(19) United States
(12) Patent Application Publication
(10) Pub. No.: US 2025/0014057 A1
(43) Pub. Date: Jan. 9, 2025

(54) INTELLIGENT ANALYTICS DASHBOARD FOR PREDICTING DEMAND CONDITIONS ACROSS A PLURALITY OF CHANNELS

(71) Applicant: SurgeTech, LLC, Austin, TX (US)

(72) Inventors: Michael Love, Marble Falls, TX (US); Blake Love, Austin, TX (US); Tiago Soromenho, Austin, TX (US); Alexander Starks, Austin, TX (US); Matthew Paff, Round Rock, TX (US)

(21) Appl. No.: 18/219,398

(22) Filed: Jul. 7, 2023

(51) Int. Cl. G06Q 30/0202; G06N 20/00

(52) U.S. Cl. CPC G06Q 30/0202; G06N 20/00

(57) ABSTRACT

This disclosure relates to improved techniques for monitoring activities across a plurality of channels and predicting conditions in the channels. In certain embodiments, channel events corresponding to the channels are collected and monitored by an analytics dashboard of a geolocation platform. A channel analysis function analyzes utilizes the channel events to generate demand predictions and/or other metrics. In some cases, the channel analysis function can execute an anomaly detection model, a time series forecasting model, and/or other learning model to generate the predictions and metrics. The analytics dashboard generate various displays to visualizing the demand predictions and/or other metrics. Other embodiments are disclosed herein as well.

### TECHNICAL FIELD

This disclosure is related to improved systems, methods, and techniques for monitoring activities across a plurality of channels and generating an interactive analytics dashboard that displays demand-related predictions and metrics pertaining to the channels.

### BACKGROUND

Predicting or determining demand for products and/or services in a geographic region is a technically, complex challenge. Many different variables can affect the level of demand for the product and/or services in a given geographic region. For example, the demand in a geographic region can vary based on a density of individuals located in the region, weather conditions in the region, and events (e.g., seminars, concerts, conferences, etc.) occurring in the region. Further, variations in the demand can be attributed to temporal factors, such as variations that occur at particular times of a day (e.g., mornings, afternoon, and evenings) or particular days of a week (e.g., weekdays and weekends), and variations that occur during particular seasons or during certain holidays. Many other variables also can impact the demand in a geographic region.

Further difficulties associated with determining or predicting demand can be attributed to the fact that certain variables affect or influence particular geographic regions more severely than other geographic regions. For example, rainy or snowy weather conditions may significantly lower demand in certain regions (e.g., such as those that typically experience moderate or sunny weather), and may have little or no impact on demand in other regions (e.g., such as those that regularly experience rain or snow). Likewise, certain holidays may be celebrated in one geographic regions causing a spike in a demand during the holiday season, but may not be celebrated in other geographic regions, thus having little or no impact on the demand in these regions.

Merchants across many verticals may desire access to accurate demand analytics, and may wish to understand when surges in demand are occurring or will occur in the future. For example, in some cases, merchants may wish to raise prices for goods or services in scenarios where there are surges in demand. Additionally, merchants can use the demand analytics to manage to optimize their inventories.

One approach for detecting surges in demand can involve detecting an increase in requests for an offering in a particular geographic area. For example, a ride-hailing company may provide an application that enables users to submit requests for drivers, and the ride-hailing company may detect a surge in demand in scenarios where large numbers of requests are received from users in a particular geographic area. In response to detecting this increased demand, the ride-hailing company may alter pricing for rides in the geographic area for a duration of time while the demand remains elevated.

The aforementioned approach has several disadvantages. One disadvantage is that this approach is reactionary, and does not enable merchants to prepare in advance for surges in demand. Additionally, the aforementioned approach to predicting demand is based on a single factor (i.e., an increase in requests), and fails to consider many other factors and sources of data that can provide a more holistic determination of the nature and extent of the surge in demand. Further, the aforementioned approach narrowly considers demand for a single type of product or service in geographic area, and does not consider the demand across other verticals in a geographic area.

### BRIEF DESCRIPTION OF DRAWINGS

To facilitate further description of the embodiments, the following drawings are provided, in which like references are intended to refer to like or corresponding parts, and in which:

FIG. 1A is a diagram of an exemplary system for analyzing activity within a geographic region in accordance with certain embodiments,

FIG. 1B is a block diagram illustrating exemplary features of a geolocation analytics platform according to certain embodiments;

FIG. 2 is a block diagram illustrating exemplary features of an analytics dashboard in accordance with certain embodiments;

FIG. 3 is a block diagram of an exemplary client system according to certain embodiments;

FIG. 4A is an exemplary graphical user interface that can be accessed via an analytics dashboard according to certain embodiments;

FIG. 4B is an exemplary graphical user interface that can be accessed via an analytics dashboard according to certain embodiments;

FIG. 4C is an exemplary graphical user interface that can be accessed via an analytics dashboard according to certain embodiments;

FIG. 4D is an exemplary graphical user interface that can be accessed via an analytics dashboard according to certain embodiments;

FIG. 4E is an exemplary graphical user interface that can be accessed via an analytics dashboard according to certain embodiments;

FIG. 4F is an exemplary graphical user interface that can be accessed via an analytics dashboard according to certain embodiments;

FIG. 4G is an exemplary graphical user interface that can be accessed via an analytics dashboard according to certain embodiments;

FIG. 4H is an exemplary graphical user interface that can be accessed via an analytics dashboard according to certain embodiments;

FIG. 4I is an exemplary graphical user interface that can be accessed via an analytics dashboard according to certain embodiments;

FIG. 4J is an exemplary graphical user interface that can be accessed via an analytics dashboard according to certain embodiments;

FIG. 4K is an exemplary graphical user interface that can be accessed via an analytics dashboard according to certain embodiments;

FIG. 4L is an exemplary graphical user interface that can be accessed via an analytics dashboard according to certain embodiments;

FIG. 4M is an exemplary graphical user interface that can be accessed via an analytics dashboard according to certain embodiments;

FIG. 5A is a block diagram illustrating examples of channel events, according to certain embodiments;

FIG. 5B is a block diagram illustrating exemplary channel analysis data, according to certain embodiments;

FIG. 6 is a flowchart illustrating an exemplary method in accordance with certain embodiments.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

The terms “left,” “right,” “front,” “rear,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

As used herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Certain data, functions, or activities may be described as “real-time,” “near real-time,” or “substantially real-time” within this disclosure. Any of these terms can refer to data or functions that are processed with a humanly imperceptible delay or minimal humanly perceptible delay. Alternatively, these terms can refer to data or functions that are processed within a specific time interval (e.g., in the order of milliseconds).

### DETAILED DESCRIPTION OF EXEMPLARY EMBODIMENTS

The present disclosure relates to systems, methods, apparatuses, and computer program products for providing a geolocation analytics platform that is configured to monitor, and provide access to, demand conditions across various channels and various verticals included in the channels. The geolocation analytics platform can be configured to generate channel analysis data based on the channel events monitored by the geolocation analytics platform. The channel events received by the geolocation analytics platform can include various data or information related to events and activities occurring within the channels and/or individuals or verticals included in the channels. The geolocation analytics platform can execute a channel analysis function that generates various channel analysis data for each channel (and/or each vertical included in each channel) based on an analysis of the conditions identified by the channel events. Amongst other things, the channel analysis function can generate demand predictions identifying or predicting a demand in each of the channels and/or in each vertical included in the channels. The geolocation analytics platform can further generate an analytics dashboard that generates various interactive interfaces that visualizes and provides access to the demand predictions and other channel analysis data. In some embodiments, these demand predictions included in the channel analysis data can be used to execute a demand adjustment function to adjust prices and/or allocations of one or more inventory items in each of the channels.

The analytics dashboard can generate, and provide access to, specially configured interfaces that are dynamically updated to display metrics and predictions related to each of the channels. Amongst other things, the analytics dashboard enables users to access and view metrics and/or predictions related to demand conditions, migration or movement patterns of individuals located in the channels, vertical analytics, inventory item analytics, and/or other useful information. Users can select and navigate through the dashboard interfaces to view these metrics and predictions for particular channels, or particular verticals included in particular channels.

The metrics and predictions generated by the geolocation analytics platform can be derived, at least in part, from the channel events collected by the geolocation analytics platform. The channel events can generally include any data relating to individuals or merchants located within a channel, activities occurring within the channel, and/or conditions associated with the channel. For example, in some embodiments, the channel events for the channel can include data indicating locations or movements of individuals (or mobile devices operated by individuals) within the channel. The channel events also can include data relating to transactions conducted within the channel, weather conditions within the channel, merchants located within the channel, and events (e.g., concerts, conventions, sporting games, etc.) occurring with the channel. The channel events can further include user-sourced data, such as data entered by users who are using a mobile device within the channel. The channel events can also be based on data received from third parties such as social media sites, weather services, payment processors, ticket vendors, etc. Further examples of channel events are described throughout this disclosure.

The geolocation analytics platform can execute channel analysis functions configured to analyze or process the channel events, and generate channel analysis data for each channel. The channel analysis data for a given channel can include various metrics relating to the channel itself, individuals and/or groups of individuals within the channel, merchants and/or verticals, and/or activities occurring within the channel. For example, the channel analysis data can indicate or predict the supply and/or demand within the channel for one or more products or services (e.g., riding sharing, hotel accommodations, parking garages, dining availability, sporting or event tickets, etc.). The channel analysis data also can identify or predict population increases and/or decreases within the channel, as well as intra-channel and inter-channel movements of individuals. The channel analysis data can include many other metrics related to the channel, individuals in the channel, merchants in the channel, and/or activities occurring within the channel. Further examples of channel analysis data are described throughout this disclosure.

The channel analysis data generated can include real-time analysis information that provides current or up-to-date data relating to the aforementioned metrics and/or other metrics described herein. The channel analysis data also can include analysis information that predicts a future status of the aforementioned metrics and/or other metrics in each of the channels. Examples of these real-time and predictive analytics are provided throughout this disclosure.

In some embodiments, the channel analysis data can be used to execute one or more demand adjustment functions. Additionally, or alternatively, the channel analysis data can be provided to one or more client systems that utilize the channel analysis data to execute the one or more demand adjustment functions. One exemplary demand adjustment function can include a pricing function that determines prices for one or more inventory items. For example, in some cases, the channel analysis data can be utilized by a surge pricing function to dynamically adjust prices for one or more inventory items in a manner that accounts for the supply and demand for the one or more inventory items. Another exemplary demand adjustment function includes an inventory management function that utilizes the channel analysis data to manage or adjust inventories (e.g., such as to dynamically reallocate inventory items among channels and/or initiate ordering of additional inventory items). In many embodiments, the demand adjustment function can factor in the channel analysis data that takes into account user-sourced data, such as preferences of the users in the channel.

Additionally, one or more deployment functions can enable the channel analysis data to be utilized by, or provided to, client systems. In some scenarios, a deployment function can be executed to automate pricing systems (e.g., surge pricing systems) and/or inventory systems using the channel analysis data. For example, the geolocation analytics platform can be interfaced with client systems that host pricing and inventory applications and the channel analysis generated by the geolocation analytics platform can be accessed by the client systems to automatically adjust the pricing of inventory (e.g., products or services) and/or automatically reallocate or reorder inventory based on the supply and demand metrics associated with the channel and/or based on the increases or decreases of individuals within the channel.

Additionally, any of channel analysis data and channel event data can be displayed to users through the analytics dashboard. For example, the analytics dashboard can display any form of channel analysis data described within this disclosure including, but not limited to, demand predictions, population density metrics, movement tracking metrics, vertical density metrics, and vertical analytics metrics. Channel events such as individual location data, weather data, event data, and other channel event data discussed in this disclosure also can be displayed to the user. The analytics dashboard can generate various maps, graphs, and other user-friendly displays to present the channel analysis data to users.

Users can interact with the geolocation analytics platform through the analytics dashboard. For example, a user can select a channel or vertical of interest and prompt the geolocation analytics platform to calculate predictions relating to the demand, population densities, migration patterns, and/or other conditions for channel and/or vertical. The user also can set certain values (e.g., values for channel event data at some point or points in time) to simulate or model how certain activity will be affected by the possible change in channel event data. The user can set threshold values related for channel events or channel analysis data to trigger the automatic transmission of alerts or notifications from the geolocation analytics platform when that threshold has been met, breached, or exceeded. The analytics dashboard also can enable a user to activate and configure settings for the deployment functions and/or demand adjustment settings described herein.

In one example, the analytics dashboard can enable a user to configure a deployment function to transmit notifications that include some or all of the channel analysis data. For example, notifications can be transmitted to client systems affiliated with merchants within designated channels to disseminate real-time data and/or predictive data relating to the supply and demand for particular products or services. The merchant notifications also can include other types of channel analysis data (e.g., population surge information, event information, transaction patterns within the channel, movement patterns of individuals with the channel, etc.). Further, the analytics dashboard can enable a user to configure the transmission of notifications to individuals located within the channel (e.g., to present offers or discounts to the individuals and/or recommend merchants located in the channel). Additional types of notification functions are described throughout this disclosure.

The technologies described herein can provide a variety of benefits and advantages. Amongst other things, predictive technologies can determine or predict conditions in the channels with greater accuracy and precision, including conditions pertaining to demand within the channels and/or demand across various verticals in the channels. Another benefit is that the analytics dashboard can generate various interactive displays that graphically illustrate the demand predictions and other channel analysis data to enable users to understand the conditions of the channels and take appropriate measures to accommodate predicted demand in the channels.

Further benefits can be attributed to the usefulness and versatility of the channel analysis data, which can be leveraged for many different purposes. For example, in some scenarios, the demand predictions can be utilized by client systems to automate pricing functions and/or inventory functions in real-time or near real-time based on the current conditions within the channels. Additionally, the demand predictions can be utilized by client systems to prepare for predicted future conditions within the channels. In some cases, the client systems can be interfaced with a geolocation analytics platform (e.g., via an application programming interface or API) to enable immediate access to the demand predictions on a continuous basis, thereby facilitating a seamless adjustment of pricing and/or inventory allocations in real-time or near real-time. This data can provide merchant entities with real-time and/or predictive metrics that can assist merchant entities with accommodating surges in supply and demand (and/or population surges within a channel).

Additional benefits can be attributed to embodiments that utilize the demand predictions to automate surge pricing functions. Client applications that employ surge pricing functionalities can better mitigate imbalances between an available supply of inventory items and a demand for those inventory items. The demand predictions can be leveraged to dynamically adjust prices for the inventory items, thereby enabling providers of the client applications to reduce high-demand peaks.

Other benefits can be attributed to the versatility of the technologies described herein, which can be leveraged to improve operations in any establishment or in any vertical. That is, the location tracking and predictive technologies can be applied to predict current and/or future supply and demand conditions for any establishment or vertical. Exemplary verticals that can benefit from these technologies can include those related to ride hailing services, transportation (e.g., ticket bookings for buses, trains, airplanes, cruises, boats, etc.), lodging accommodations (e.g., affiliated with hotels, motels, short-term home stays, rental services, property purchases, etc.), parking services (e.g., affiliated with parking garages, parking lots, etc.), restaurant services, tavern services, entertainment services, etc. For example, the technologies disclosed herein can provide vertical-specific or merchant-specific insights and metrics regarding the current and future demand for products and services offered in these verticals or by these entities. These metrics can be used by those entities to automatically or manually adjust settings for pricing systems (e.g., surge pricing systems), inventory systems, and/or other operations. Additionally, in some embodiments, by using user-sourced information from users in the channel, and/or extrapolating information more generally about other individuals in the channel based on the user-sourced information, the insights and metrics provided to specific merchants and/or in specific verticals can be more accurate.

The embodiments described in this disclosure can be combined in various ways. Any aspect or feature that is described for one embodiment can be incorporated to any other embodiment mentioned in this disclosure. Moreover, any of the embodiments described herein may be hardware-based, may be software-based, or, preferably, may comprise a mixture of both hardware and software elements. Thus, while the description herein may describe certain embodiments, features, or components as being implemented in software or hardware, it should be recognized that any embodiment, feature and/or component referenced in this disclosure can be implemented in hardware and/or software.

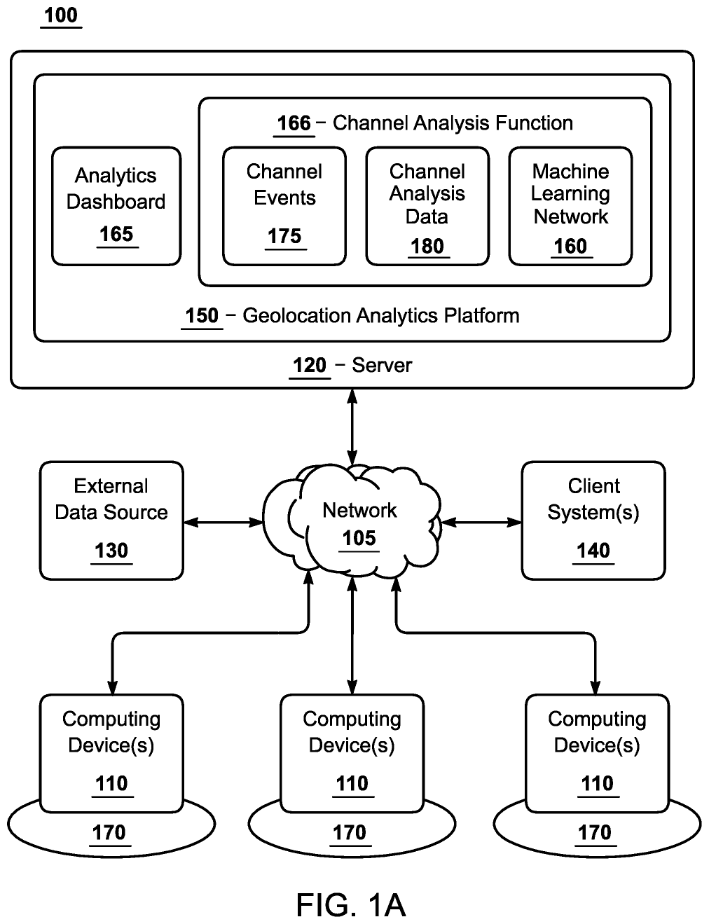

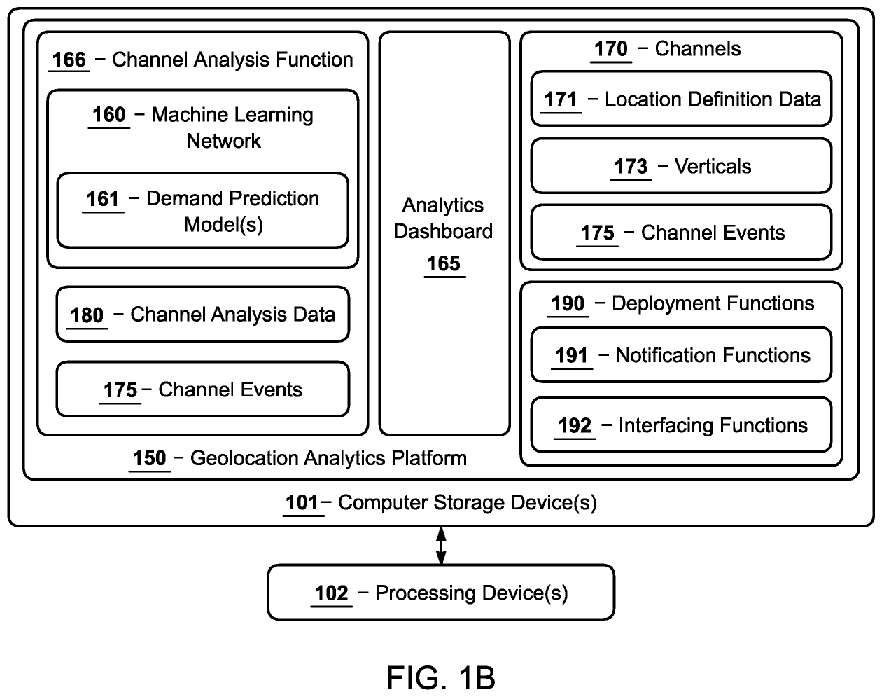

FIG. 1A is a diagram of an exemplary system 100 in accordance with certain embodiments that includes, inter alia, a geolocation analytics platform 150 that generates demand information for a plurality of channels 170. FIG. 1B is a diagram illustrating exemplary features, components, and/or functions associated with the geolocation analytics platform 150. FIGS. 1A and 1B are jointly discussed below.

The system 100 comprises one or more computing devices 110, one or more servers 120, one or more external data sources 130, and one or more client systems 140 that are in communication over a network 105. A geolocation analytics platform 150 is stored on, and executed by, the one or more servers 120. The network 105 may represent any type of communication network, e.g., such as one that comprises a local area network (e.g., a Wi-Fi network), a personal area network (e.g., a Bluetooth network), a wide area network, an intranet, the Internet, a cellular network, a television network, and/or other types of networks.

All the components illustrated in FIG. 1A, including the one or more computing devices 110, one or more servers 120, one or more external data sources 130, and one or more client systems 140, and geolocation analytics platform 150 can be configured to communicate directly with each other and/or over the network 105 via wired or wireless communication links, or a combination of the two. Each of the computing devices 110, servers 120, external data sources 130, client systems 140, and geolocation analytics platform 150 can include one or more communication devices, one or more computer storage devices 101, and one or more processing devices 102 (FIG. 1B) that are capable of executing computer program instructions.

The one or more computer storage devices 101 may include (i) non-volatile memory, such as, for example, read only memory (ROM) and/or (ii) volatile memory, such as, for example, random access memory (RAM). The non-volatile memory may be removable and/or non-removable non-volatile memory. Meanwhile, RAM may include dynamic RAM (DRAM), static RAM (SRAM), etc. Further, ROM may include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In certain embodiments, the one or more computing storage devices 101 may be physical, non-transitory mediums. The one or more computer storage devices 101 can store, inter alia, instructions associated with implementing the functionalities of the geolocation analytics platform 150 described herein.

The one or more processing devices 102 may include one or more central processing units (CPUs), one or more microprocessors, one or more microcontrollers, one or more controllers, one or more complex instruction set computing (CISC) microprocessors, one or more reduced instruction set computing (RISC) microprocessors, one or more very long instruction word (VLIW) microprocessors, one or more graphics processor units (GPU), one or more digital signal processors, one or more application specific integrated circuits (ASICs), and/or any other type of processor or processing circuit capable of performing desired functions. The one or more processing devices 102 can be configured to execute any computer program instructions that are stored or included on the one or more computer storage devices 101 including, but not limited to, instructions associated with implementing the functionalities of the geolocation analytics platform 150 described throughout this disclosure.

Each of the one or more communication devices can include wired and wireless communication devices and/or interfaces that enable communications using wired and/or wireless communication techniques. Wired and/or wireless communication can be implemented using any one or combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.).

Exemplary PAN protocol(s) can comprise Bluetooth, Zigbee, Wireless Universal Serial Bus (USB), Z-Wave, etc. Exemplary LAN and/or WAN protocol(s) can comprise Institute of Electrical and Electronic Engineers (IEEE) 802.3 (also known as Ethernet), IEEE 802.11 (also known as WiFi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware can depend on the network topologies and/or protocols implemented. In certain embodiments, exemplary communication hardware can comprise wired communication hardware including, but not limited to, one or more data buses, one or more universal serial buses (USBs), one or more networking cables (e.g., one or more coaxial cables, optical fiber cables, twisted pair cables, and/or other cables). Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.). In certain embodiments, the one or more communication devices can include one or more transceiver devices, each of which includes a transmitter and a receiver for communicating wirelessly. The one or more communication devices also can include one or more wired ports (e.g., Ethernet ports, USB ports, auxiliary ports, etc.) and related cables and wires (e.g., Ethernet cables, USB cables, auxiliary wires, etc.).

In certain embodiments, the one or more communication devices additionally, or alternatively, can include one or more modem devices, one or more router devices, one or more access points, and/or one or more mobile hot spots. For example, modem devices may enable some or all of the computing devices 110, servers 120, external data sources 130, client systems 140, and/or geolocation analytics platform 150 to be connected to the Internet and/or other networks. The modem devices can permit bi-directional communication between the Internet (and/or other networks) and the computing devices 110, servers 120, external data sources 130, client systems 140, and/or geolocation analytics platform 150. In certain embodiments, one or more router devices and/or access points may enable the computing devices 110, servers 120, external data sources 130, client systems 140, and/or geolocation analytics platform 150 to be connected to a LAN and/or other networks. In certain embodiments, one or more mobile hot spots may be configured to establish a LAN (e.g., a Wi-Fi network) that is linked to another network (e.g., a cellular network). The mobile hot spot may enable the computing devices 110, servers 120, external data sources 130, client systems 140, and/or geolocation analytics platform 150 to access the Internet and/or other networks.

In certain embodiments, the computing devices 110 may represent desktop computers, laptop computers, mobile devices (e.g., smart phones, personal digital assistants, tablet devices, vehicular computing devices, wearable devices, or any other device that is mobile in nature), and/or other types of devices. The one or more servers 120 may generally represent any type of computing device, including any of the aforementioned computing devices 110. The one or more servers 120 also can comprise one or more mainframe computing devices and/or one or more virtual servers that are executed in a cloud-computing environment. In some embodiments, the one or more servers 120 can be configured to execute web servers and can communicate with the computing devices 110, external data sources 130, client systems 140, and/or other devices over the network 105 (e.g., over the Internet).

In certain embodiments, the geolocation analytics platform 150 can be implemented as a software-as-a-service (SaaS) platform, and may host one or more applications (e.g., one or more web-based applications) that are made available to users of the computing devices 110 over the network 105. For example, the geolocation analytics platform 150 may offer separate accounts to users (e.g., which may correspond to individuals, merchants, companies, businesses, and/or other entities). In certain embodiments, in response to a user creating an account, the geolocation analytics platform 150 may create a separate instance of one or more applications offered by the platform and the separate instance may be associated with the account. Users may access their accounts to view various types of channel analysis data, configure notification settings, interface client systems 140 with the geolocation analytics platform 150, and perform other functions described herein.

In certain embodiments, the geolocation analytics platform 150 can be stored on, and executed by, the one or more servers 120. Additionally, or alternatively, the geolocation analytics platform 150 can be stored on, and executed by, the one or more computing devices 110 and/or one or more client systems 140. The geolocation analytics platform 150 can be stored on, and executed, by other devices as well.

In some embodiments, the geolocation analytics platform 150 also can be stored as a local application on a computing device 110, or interfaced with a local application stored on a computing device 110, to implement the techniques and functions described herein. The computing device 110 may be part of client system 140 in some scenarios.

The client systems 140 can generally correspond to third-party systems, networks, and/or devices that access the geolocation analytics platform 150 and/or utilize the data generated by the geolocation analytics platform 150. For example, the client systems 140 can be operated and managed by individuals, businesses, and/or other entities that utilize the geolocation analytics platform 150 (including data generated by the geolocation analytics platform 150) to improve the functionalities of one or more systems and/or one or more applications.

In certain embodiments, each of the client systems 140 can register and/or create a user account with the geolocation analytics platform 150 to obtain access to the data and services provided by the geolocation analytics platform 150. The client systems 140 can be operated by, or associated with, individuals or businesses from any industry or vertical including, but not limited, to those that offer ride hailing services, hotel or lodging accommodations, parking space availability, tavern services, and restaurant services. As explained in further detail below, the client systems 140 can utilize the data provided by the geolocation analytics platform 150 to enhance and improve business operations in various ways.

Each of the client systems 140 may include one or more computing devices 110 that enable the client systems 140 to access the geolocation analytics platform 150 over the network 105. In some cases, one or more of the client systems 140 may include sophisticated technological infrastructures, such as those that include enterprise systems, servers 120, virtual private networks (VPNs), intranets, etc. The computing devices 110, servers 120, and/or other devices associated with each client system 140 can store and execute various applications (e.g., such as ride hailing applications, lodging booking applications, dining reservation applications, pricing applications, inventory management applications, etc.). The client systems 140 and associated applications can leverage the data provided by the geolocation analytics platform 150 in various ways.

In certain embodiments, the geolocation analytics platform 150 can be integrated with (or can communicate with) various applications hosted by the client systems 140 including, but not limited to, applications that provide products or services for transportation services (e.g., ride hailing services, ride sharing services, vehicle rental services, and/or ticket scheduling services for buses, trains, planes, boats, and/or other modes of transportation), lodging accommodations (e.g., booking services for hotels, motels, short-term home stays, rental services, property purchases, etc.), parking services (e.g., booking services for parking garages, parking lots, etc.), and scheduling services (e.g., reservation services for restaurants, bars, clubs, sporting events, concerts, ticketed events, etc.). In certain embodiments, the geolocation analytics platform 150 additionally, or alternatively, can be integrated with (or can communicate with) e-commerce applications, pricing applications, inventory management applications, and/or other applications.

The aforementioned applications and/or other applications, each of which may be integrated or interfaced with the geolocation analytics platform 150, can be stored on one or more client systems 140 in some embodiments. For example, the aforementioned applications and/or other applications can be stored on one or more computing device 110 and/or one or more servers 120 associated with one or more client systems 140.

As discussed throughout this disclosure, the geolocation analytics platform 150 can generally provide functions relating to monitoring and analyzing demand conditions across a plurality of channels 170. The geolocation analytics platform 150 also is configured to generate an analytics dashboard 165 that provides various interactive displays and interfaces, which permit users to access and utilize various metrics derived by the geolocation analytics platform 150.

In certain embodiments, the geolocation analytics platform 150 receives channel events 175 corresponding to activities, individuals, merchants, events, and/or the like within the channels 170, and utilizes the channel events 175 to generate channel analysis data 180 corresponding to each of the channels 170. For each channel 170, the channel analysis data 180 can include various metrics and information useful for understanding and/or predicting the demand conditions within the channel 170. For example, the channel analysis data 180 generated for a given channel 170 can include information that indicates and/or predicts population surges within the channel 170, movements of individuals within the channel, and/or supply and demand for inventory items (e.g., products or services) within the channel 170. Additionally, as described in further detail below, the channel analysis data 180 derived by the geolocation analytics platform 150 can be utilized to execute demand adjustment functions (e.g., functions that facilitate dynamic adjustment of prices and/or inventories within the channels 170). These demand adjustment functions can be executed by the geolocation analytics platform 150 and/client systems 140 interfaced with the geolocation analytics platform 150.

Each channel 170 can represent, or correspond to, a specific geographic region or area. The scope or region associated with each channel 170 can vary significantly. For example, macro-level channels 170 can correspond to large geographic areas covering entire continents, countries, and/or states. Other more micro-level channels 170 can correspond to counties, cities, and/or towns. Additional channels 170 can correspond to specific regions, neighborhoods, areas, or the like within cities or towns. In many cases, the channels 170 can include overlapping geographic areas (e.g., such that a channel corresponding to a city can be included within a channel corresponding to a state, and the channel corresponding to the state can be included in a channel corresponding to a country). Regardless of geographic scope, the geolocation analytics platform 150 is configured to process data associated with the channel 170 and generate demand prediction data for the channel 170.

The geolocation analytics platform 150 can store location definition data 171 that defines the geographic region associated with each channel 170. For example, in certain embodiments, the location definition data 171 can store global positioning system (GPS) coordinates for each channel 170 that precisely defines the geographic region associated with the channel 170. Additionally, or alternatively, the location definition data 171 can include geo-fencing data that defines the geographic region associated with the channel 170. The geolocation analytics platform 150 can provide access to one or more graphical user interfaces or dashboards that enable users to interact with geolocation analytics platform 150, including by defining the geographic regions associated with the channels 170.

Each channel 170 can include one or more verticals 173, or categorizations of merchants within the channel 170. Verticals 173 can group merchants together based on any number of shared characteristics such as the nature of the business, the size of the business, goods and services offered, independent or franchise, etc. In some embodiments, each vertical 173 may correspond to businesses that provide similar or complimentary products or services. Exemplary verticals 173 can include broad categories of products or services (e.g., transportation or lodging) and/or more specific categories of products or services (e.g., ride hailing services, hotel accommodations, parking garages, tavern services, restaurant services, etc.).

The geolocation analytics platform 150 can receive channel events 175 from each of the channels 170. The channel events 175 can generally include any data relating to individuals located within a channel 170, activities occurring within the channel 170, and/or other conditions associated with the channel 170. For example, in some embodiments, the channel events 175 for a given channel 170 can include data indicating locations or movements of individuals (or mobile devices operated by individuals) within the channel 170. The channel events 175 also can include data relating to transactions conducted within the channel 170, weather conditions within the channel 170, merchants located within the channel 170, and events (e.g., concerts, conventions, sporting games, etc.) occurring with the channel 170.

Additionally, the channel events 175 can include user-sourced data, such as data entered by users who are using a mobile device within the channel 170. Such mobile devices can provide an application that allow the users to enter the user-sourced data. For example, an application provided by a client system 140 can be used by the users to enter user-sourced data. The channel events 175 also can include other data, such as location data associated with the mobile devices of the users with the channel 170. The location data and the user-sourced data can be correlated to associate the users with location information. The channel events 175 can include many additional attributes related to the channel 170 itself and/or users within the channel 170. Further examples of channel events 175 are described throughout this disclosure.

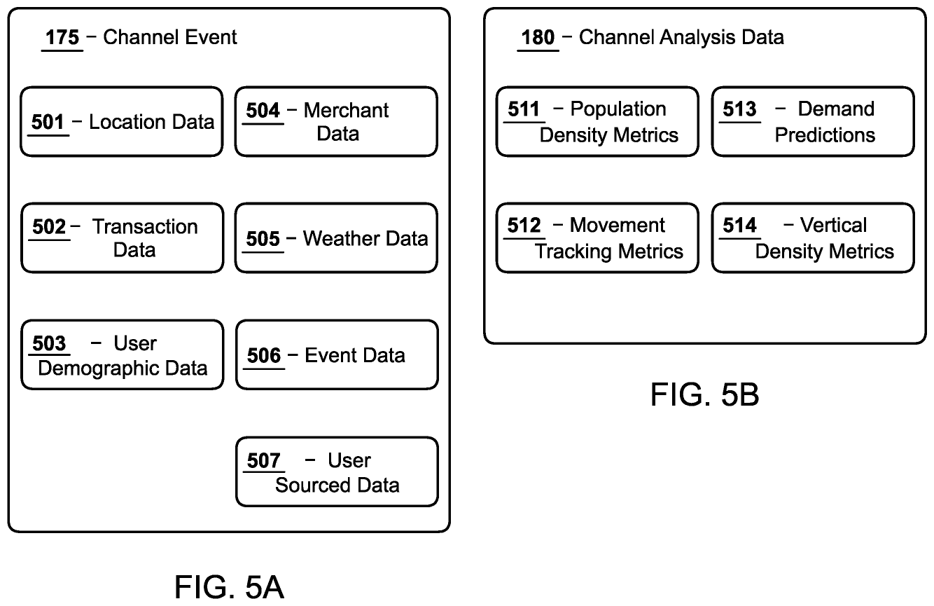

FIG. 5A is a block diagram illustrating examples of channel events 175 that can be received by the geolocation analytics platform 150. As shown, the channel events 175 can include, inter alia, location data 501, transaction data 502, user demographic data 503, merchant data 504, weather data 505, event data 506, and user-sourced data 507.

The location data 501 can indicate the current locations and/or historical locations and movements of individuals (or computing devices 110 operated by individuals) located in the channel 170. For example, the location data 501 may include GPS coordinates indicating the current locations of individuals, and previous locations of those individuals. In some embodiments, the location data 501 can be received directly from computing devices 110 operated by the individuals (e.g., users) and/or from an external data source 130, such as a cellular service provider.

The transaction data 502 can indicate purchases that are made within the channel 170 and/or purchases made by individuals that are currently located within the channel 170. The transaction data 502 also may indicate transaction patterns or profiles for each of the individuals located in the channel 170 (e.g., indicating the types of products or services routinely purchased by the individual and/or the types of businesses routinely frequented by the individual). In some cases, the transaction data 502 also may indicate the channel 170 where each transaction was conducted. In some embodiments, the transaction data 502 can be received directly from computing devices 110 operated by the individuals and/or an external data source 130, such as a third-party merchant system, credit card service provider, digital payments provider, etc.

The user demographic data 503 can include information about the users that can be used to categorize the users or sort them into groups. Examples of demographic data 503 includes the age, gender, race, ethnicity, religion, marital status, employment status, and income. The user demographic data 503 can be received directly from computing devices 110 operated by the individuals and/or from an external data source 130 such as a social media network, etc.

The merchant data 504 can provide information related to merchants (e.g., businesses, vendors, etc.) or establishments located in the channel 170. For example, the merchant data 504 may identify the locations of the merchants, the vertical 173 associated with the merchants, hours of operation, and products or services offered by the merchants. In some embodiments, the merchant data 504 can be received directly from computing devices 110 operated by the merchants and/or an external data source 130, such as a crowd-sourced business review applications, business information databases, social media networks, etc.

The weather data 505 can indicate the current weather conditions and/or historical weather conditions in the channel 170. The weather data 505 also may indicate forecasts of future weather conditions for the channel 170. In some embodiments, the weather data 505 can be received from one or more external data sources 130, such as those that provide weather forecasting services.

The event data 506 can provide information associated with events (e.g., concerts, conventions, seminars, shows, etc.) in the channel 170. The event data 506 can include information identifying ongoing events, as well as previously held or upcoming events. The event data 506 may include dates and times associated with each of the events. In some embodiments, the event data 506 can be received directly from computing devices 110 operated by event providers and/or an external data source 130, such as social media sites, theatres, cinemas, ticketing agencies, community bulletin board sites, etc.

The user-sourced data 507 received can include information provided by individuals using their computing devices 110 received by the geolocation analytics platform 150. Examples of user-sourced data 507 includes psychographics data (the individuals' interests, values, attitudes, lifestyles, behaviors, opinions, beliefs, activities, etc.), user preference data, and user feedback data. The user-sourced data 507 may also include user demographic data 503 and transaction data 502.

The categories identified in FIG. 5A are intended to provide examples of content that may be included in channel events 175. However, it should be recognized that the channel events 175 can include additional information or data related to the activities, individuals, entities, and/or conditions of the channel 170.

Returning to FIGS. 1A and 1B, the geolocation analytics platform 150 can execute a channel analysis function 166 to analyze the channel events 175, and generate channel analysis data 180 for each of the channels 170. As discussed in further detail below, in some embodiments, the channel analysis function 166 can include, or may utilize, a machine learning network 160 to generate at least a portion of the channel analysis data 180 for each channel 170. The channel analysis data 180 can include various types of metrics or data useful for understanding the conditions associated with the channel 170. In many scenarios, the channel analysis data 180 can include real-time information regarding the current channel conditions and/or predictions related to future channel conditions. For example, in many embodiments, the channel analysis data 180 can, inter alia, include demand predictions for current time periods and/or future time periods.

FIG. 5B is a block diagram illustrating examples of channel analysis data 180 that can be generated by the machine learning network 160 and/or other component of the geolocation analytics platform 150. In some embodiments, the channel analysis function 166 executed by geolocation analytics platform 150 may generate channel analysis data 180 that includes population density metrics 511, movement tracking metrics 512, demand predictions 513, and/or vertical density metrics 514 for each of the channels.

The population density metrics 511 generated by the geolocation analytics platform 150 can indicate or predict a density or number of individuals located in each channel 170. In some instances, the population density metrics 511 can be utilized to detect occurrences or situations in which the number of individuals located within the channel 170 (or certain regions in the channel 170) significantly increases and/or decreases. In some embodiments, the population density metrics 511 can include data that identifies densities of individuals throughout or within a channel 170. For example, the population density metrics 511 can indicate regions within the channel 170 where there is a high density of users and/or other individuals and/or regions within the channel 170 where there are lower densities of individuals. In some cases, the population density metrics 511 for a channel 170 can be generated, at least in part, by monitoring locations (e.g., GPS coordinates) of individuals' computing devices 110 (e.g., smart phones or mobile devices), and determining the number of computing devices 110 that are located within the channel 170 (or region within the channel).

In certain embodiments, the geolocation analytics platform 150 also can be configured to predict population density metrics 511 in a future period of time. For example, in some instances, the geolocation analytics platform 150 can be configured to predict scenarios in which the population in a channel 170 will vary from the average or baseline population. These predictions can be generated based, at least in part, on an analysis of historical channel events 175 that are stored and collected by the geolocation analytics platform 150. For example, the event data 506 included in the channel events 175 can be utilized to identify times and locations in which a population surge is likely to occur in the channel 170 (or regions within the channel 170) as the result of an upcoming event (e.g., such as a concert). Additionally, or alternatively, the location data 501 included in the channel events 175 can be used to predict upcoming expansions or retractions of populations within a channel 170 (or regions within a channel 170) based on an analysis of individuals' current locations and/or based on historical movement patterns. Additionally, or alternatively, the weather data 505 included in the channel events 175 also may be utilized to predict the population density metrics 511 based on expected weather conditions for future time periods. Additionally, or alternatively, the user-sourced data 507 can be used to predict population density metrics 511, such as by determining individuals that will likely participate in an upcoming event, or would likely use an establishment after a currently occurring event ends.

The movement tracking metrics 512 can include various metrics indicating and/or predicting the locations or movements of individuals within the channel 170. The movement tracking metrics 512 can include data indicating where individuals have moved within the channel 170, and locations where those individuals originated. The movement tracking metrics 512 also can include data that indicates movement or migration patterns of users and/or other individuals (both intra-channel movement patterns and inter-channel movement patterns). For example, based on an analysis of historical location data 501, the movement tracking metrics 512 may indicate historical movement patterns of individuals within the channel 170.

The movement tracking metrics 512 also can include data that predicts the movements of users and/or other individuals throughout a channel 170 in a future time period. For example, the movement tracking metrics 512 can predict regions within a channel 170 where individuals are likely to migrate. The movement tracking metrics 512 can be generated based, at least in part, on the channel events 175 (e.g., such as the location data 501 indicating current and historical locations of individuals, user-sourced data 507, and event data 506 indicating current or upcoming events within the channel 170).

The demand predictions 513 can indicate or predict the demand in the channels 170 in various ways. Each demand prediction 513 can indicate or predict the demand for a given channel 170, the demand for a vertical included in the channel 170, and/or the demand for one or more inventory items offered within the channel 170. In some embodiments, demand predictions 513 can be based on a consideration of the supply and/or demand conditions in the channel 170, the supply and/or demand conditions for a vertical within the channel 170, and/or the supply and/or demand conditions for one or more inventory items within the channel 170. The demand predictions 513 can include real-time metrics relating to the current or real-time demand in the channels (or verticals or inventory items corresponding to the channels). The demand predictions 513 also can predict the demand for the channels (or verticals or inventory items corresponding to the channels) in future time periods.

In some embodiments, the demand predictions 513 can include various metrics indicating and/or predicting supply and/or demand within the channel 170 for various inventory items 335 (e.g., products and/or services) at one or more establishments or in one more verticals 173 (e.g., riding sharing, hotel accommodations, parking garages, restaurants, bars, retail, etc.). The current or future supply and/or demand for inventory items 335 may be determined based, at least in part, on an analysis of the population density metrics 511 (e.g., which can indicate or predict the densities of users and/or other individuals within the channel 170 or regions within the channel 170). Additionally, or alternatively, the supply and/or demand for inventory also may be based on an analysis of channel events 175 received by the geolocation analytics platform 150, such as channel events 175 that include user-sourced data 507 (e.g., users preferring speed over cost-consciousness for a given inventory item 335), transaction data 502 (e.g., which may indicate recent or historical purchases made within the channel 170), weather data 505 (e.g., which may indicate weather conditions affecting the demand for inventory), merchant data 504 (e.g., which may indicate the supply of an inventory item 335 in the channel 170), the correlations of the location data and the user-sourced data 507 (e.g., the history of a user utilizing certain establishments or verticals in view of the user's preferences), and/or other channel events 175.

The vertical density metrics 514 for a channel 170 can indicate the density or quantity of individuals that are located in each of the verticals 173 within the channel 170. The vertical density metrics 514 can include data, which can be used to identify upwardly and downwardly trending population surges in each of a plurality of verticals 173 within each channel 170. In certain embodiments, each merchant located in a channel 170 may be affiliated or associated with one or more verticals 173, and the vertical density metrics 514 may be determined by tracking locations of individuals and merchants in a channel, and correlating the location data for individuals with the location data for merchants.

The population density metrics 511, movement tracking metrics 512, demand predictions 513, and vertical density metrics 514 are provided as examples of channel analysis data 180. However, it should be recognized that the channel analysis data 180 can include many other types of metrics or analytics relevant to the conditions of the channels 170.

Returning to FIGS. 1A and 1B, the geolocation analytics platform 150 includes a machine learning network 160 that can be configured to generate one or more of the metrics included in the channel analysis data 180 (including, but not limited to, the population density metrics 511, movement tracking metrics 512, demand predictions 513, and vertical density metrics 514). For example, the machine learning network 160 may include one or more learning models that are trained to determine or predict each of these metrics.

In one example, the machine learning network 160 includes one or more learning models that are configured to generate or predict the demand predictions 513 described herein. The machine learning network 160 can be configured generate or predict real-time demand predictions 513 corresponding to current time period and/or demand predictions 513 for a future period of time. As described above, these demand predictions 513 can indicate or predict the demand for a given channel 170, the demand for a vertical included in the channel 170, and/or the demand for one or more inventory items offered within the channel 170. The techniques and learning models utilized to generate the demand predictions 513 can vary.

In certain embodiments, the machine learning network 160 includes at least one demand prediction model 161 that is configured to generate the demand predictions 513. The demand prediction model 161 can include one or more anomaly detection models that are trained to detect patterns indicative of current or real-time demand conditions within the channels. Exemplary anomaly detection models can be implemented using change point detection (CPD), outlier detection (OD), and/or classification techniques to derive demand predictions 513 corresponding to the channels 170. The demand prediction models 161 also can include one or more time series forecasting models that are trained to predict future demand conditions within the channels 170. Exemplary time series forecasting models can utilize gradient boosting machine (GBM), autoregressive integrated moving average (ARIMA), seasonal autoregressive integrated moving average (SARIMA), autoregressive recurrent neural network (ARNN), and/or long short-term memory (LSTM) techniques to generate demand predictions 513 corresponding to the channels 170. In some embodiments, the anomaly detection models can include a classification model that is pre-trained using a supervised training procedure to generate the one or more demand predictions and the classification model generates the demand metric using one or more of the following: a Naive Bayes classification model; a OCSVM (One-class support vector machine) classification model; a SVDD (Support Vector Data Description) classification model; or a one-class K-means classification model.

The demand prediction models 161 can be trained using various supervised, unsupervised, and/or semi-supervised training procedures. For example, certain demand prediction models 161 that are implemented using change point detection or outlier detection techniques may be trained in an unsupervised fashion using training features that are extracted from channel events aggregated by the geolocation analytics platform 150 over a historical time period. Other demand prediction models 161, such as those that are implemented using classification or times series forecasting techniques, can be trained in a supervised or semi-supervised fashion using training features that are annotated with demand indicator labels identifying demand levels in the channels 170 based on given sets of channel features derived from a historical time period. These and other training techniques are described in further detail below.

In certain embodiments, the demand prediction models 161 can be trained on a channel-specific basis using training features that are specific to each channel 170. As explained above, different variables can affect the demand in each channel 170, and the impact or severity of each variable can differ across channels 170. To account for these variations, the demand prediction models 161 can be separately trained on a channel-specific basis using training features that are specific to that channel 170 (e.g., using channel features that are derived from channel events corresponding to the channel in a historical time period). Training the demand prediction models 161 in this manner can significantly improve the accuracy of the demand metrics generated or predicted for each of the channels 170.

In certain embodiments, the demand prediction models 161 can be trained on a channel-specific basis using training features that are specific to each channel 170. Different variables can affect the demand in each channel 170, and the impact or severity of each variable can differ across channels 170. To account for these variations, the demand prediction models 161 can be separately trained, at least in part, on a channel-specific basis using training features that are specific to that channel 170 (e.g., using channel features that are derived from channel events corresponding to the channel in a historical time period). Training the demand prediction models 161 in this manner can significantly improve the accuracy of the demand metrics generated or predicted for each of the channels 170.

The channel features utilized by the machine learning network 160 can be derived, at least in part, from the channel events 175 that are received by the geolocation analytics platform 150. As explained above, the geolocation analytics platform 150 can receive and monitor various types of channel events 175 for each of the channels 170, and the channel events 175 can generally include any data relating to monitoring past, present or future conditions associated with the channels (e.g., relating movements of individuals, transactions conducted in the channels, weather conditions, etc.). For each channel, the machine learning network 160 can extract channel features from the channel events 175 and/or the channel analysis data 180 derived from the channel events 175. The channel features can generally include any data that can impact or affect demand conditions in a channel 170. For example, the channel features can be extracted to indicate or predict a density or amount of individuals located in each channel 170. Additionally, the channel features also can comprise temporal features (e.g., which may identify a season, a day of a week, a time of day, occurrences of holidays, etc.) that affect the demand. Additional channel features can include data relating to available inventory supplies, weather conditions, scheduled events, and other factors that can affect the demand conditions in each channel 170.

The channel features for each channel 170 can be utilized by one or more demand prediction models 161 to generate the demand predictions 513 corresponding to each of the channels 170. Each demand prediction 513 can indicate or predict the demand for a channel 170, the demand for a vertical included in the channel, and/or the demand for one or more inventory items associated with the channel.

During a training phase of the machine learning network 160, separate sets of channel features can be collected or aggregated to create one or more training data sets that are utilized to train one or more of the demand prediction models 161 described herein. Additionally, for some models that learn via supervised training, the channel features can be annotated with demand indicator labels. During an operational or deployment phase of the machine learning network 160, the channel features can be provided to one or more pre-trained demand prediction models to generate the demand metrics.

Moving on, the geolocation analytics platform 150 provides users with various selectable options for its configuration, including one or more deployment functions 190. The deployment functions 190 can permit platform users to leverage the channel analysis data 180 (and other data generated by the geolocation analytics platform 150) for various purposes.

One exemplary deployment function 190 can include a notification function 191. The notification function 191 enables users to configure the transmission of notifications in various scenarios. The notifications can be transmitted in various ways (e.g., via e-mail, cellular text messages, inbox messages on platform user accounts, data presented on the analytics dashboard 165, etc.) and the notifications can be sent to various devices (e.g., client systems 140, mobile or computing devices operated by individuals located in a channel 170, etc.).

Another exemplary deployment function 190 can include an interfacing function 192. The interfacing function 192 can permit a platform user to interface the geolocation analytics platform 150 with various external applications and/or systems (e.g., such as client systems 140), thereby enabling those applications and/or systems to receive and utilize the channel analysis data 180 generated by the geolocation analytics platform 150.

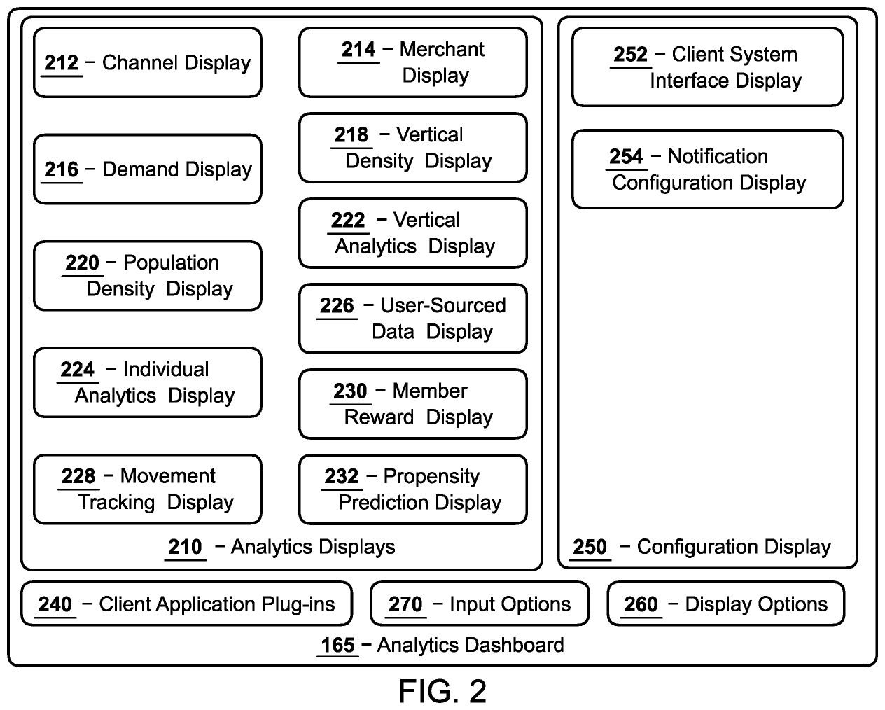

The geolocation analytics platform 150 also can include an analytics dashboard 165 that displays and/or provides access to the channel analysis data 180 in a variety of formats, and permits users to interact with the channel analysis data 180 in variety of ways. Generally speaking, the analytics dashboard 165 can be configured to generate various graphical user interfaces (GUIs) that provide access to, and display, any of the channel analysis data 180, channel events 175, and other data collected or processed by the geolocation analytics platform 150 to users operating computing devices 110. As explained in further detail below, the analytics dashboard 165 can be configured to display the aforementioned data and/or other data to users through a variety of display options (such as display options 260 in FIG. 2). The analytics dashboard 165 also can provide users with various configuration options, such as those facilitate transmission of notifications and/or interfacing with client systems 140.

FIG. 2 is a block diagram illustrating exemplary features, components, and/or functions of an analytics dashboard 165 according to certain embodiments. The analytics dashboard 165 can include one or more analytics displays 210, one or more configuration displays 250, one or more display options 260, and/or one or more input options 270. The analytics dashboard 165 can also support one or more client application plug-ins 240.

The analytics displays 210 can display any data collected or processed by the geolocation analytics platform 150. In certain embodiments, each of the analytics displays 210 can correspond to one or more GUIs that are generated by the analytics dashboard 165 and displayed to users on computing devices 110 and/or client systems 140. In some scenarios, the analytics displays 210 can be displayed to users in response to selections made by the users (e.g., using the input options 270). Additionally, or alternatively, the analytics displays 210 can be presented automatically based on a user's pre-selected preferences, the business or industry in which the user is involved, or the nature of the data requested from the geolocation analytics platform 150.

Exemplary analytics displays 210 that may be presented in connection with the analytics dashboard 165 can include: a channel display 212, a merchant display 214, a demand display 216, a vertical density display 218, a population density display 220, a vertical analytics display 222, an individual analytics display 224, a user-sourced data display 226, a movement tracking display 228, a member reward display 230, and a propensity prediction display 232. While these analytics displays 210 are illustrated as separate components in FIG. 2, it should be understood that these interfaces can be combined in various ways and any data described as being output on one analytics display 210 can be combined or integrated with any of the other analytics displays 210.

The channel display 212 can include one or more interactive graphical user interfaces that enable users to navigate through and access the channels 170 that are monitored by the geolocation analytics platform 150. For example, in some cases, the channel display 212 may provide an interactive geographic map (e.g., based on satellite imagery or illustrations) that displays the boundaries of channels 170 located in a geographic region that is currently being displayed on the channel display 212. Users can utilize the channel display 212 to select desired channels 170 of interest, and to view various information pertaining to the channels 170.

The user can zoom in or expand the channel display 212 to view more granular or specific areas of the map (and corresponding channels 170 identified on the map), and also can zoom out in the channel display 212 to view a broader portion of the map. In certain embodiments, the channels 170 can overlap with each other and/or a channel 170 can include one or more sub-channels. Thus, zooming in may permit users to view more granular channels 170 located within a channel currently displayed on the map, and zooming out may permit users to view channels 170 that have broader geographic scope.

As mentioned above, the geolocation analytics platform 150 can store location definition data 171 that defines the boundaries of the channels 170 (e.g., using GPS coordinates or geo-fencing). In some instances, the boundaries of the channels 170 can correspond to political boundaries, such as borders between nations or between states, counties, cities, towns, or neighborhoods, or other artificial markers created by a political entity. Additionally, the channel display 212 also can be configured to allow users to create custom channels 170 by specifying location definition data 171 on an interface that displays a map. Regardless of how the channels 170 are defined, the channel display 212 can access the location definition data 171 to determine the boundaries of the channels 170, and can generate an overlay for a map that shows the boundaries superimposed on a geographic area that is presented on the channel display 212.

Users may select certain channels 170 in the channel display 212 to view or access additional information pertaining to the selected channel 170. The information displayed regarding the selected channel 170 may include any data collected or processed by the geolocation analytics platform 150, including channel events 175 (as described in more detail with reference FIG. 5A), location definition data 171, and channel analysis data 180 (as described in more detail with reference to FIG. 5B). In certain embodiments, some or all of the channel analysis data 180 corresponding to the selected channel may be displayed on the channel display 212. For example, selecting a channel 170 can allow the user to view demand predictions 513 generated for the channel 170 (e.g., such as a global demand metric for the channel 170 and/or demand metrics 511 for specific verticals or inventory items), along with population density metrics 511, movement tracking metrics 512, vertical density metrics 514 for the channel. This information regarding the selected channel 170 may be formatted based on one more display options 260.

Additionally, in some cases, the map and/or channel(s) 170 presented in the channel display 212 can be supplemented with various types of annotations to display or indicate the channel analysis data 180 generated for the channel 170. For example, a heat map overlay can be provided to show or indicate the demand, population densities, vertical densities and other information. Likewise, certain graphical icon annotations can be utilized to identify channels and/or verticals that are experiencing surges in demand, and other graphical icon annotations (e.g., such as arrows, direction indicators, or the like) can be used to display the movement tracking metrics. Many other types of annotations also can be used in the channel display 212.

The merchant display 214 can include one or more interactive graphical user interfaces that display data relating to locations of various merchants in a certain channel 170 or a plurality of channels 170. In certain embodiments, the merchant display 214 can represent an overlay to the map that is presented in the channel display 212 which includes annotations identifying locations of merchants. In some cases, a user can select a channel 170 or channels 170 to view locations related to a certain merchant or an associated vertical 173. The user may select a certain merchant location to view additional data related to that location. This additional data may include data showing population densities at specific merchant locations and/or in specific verticals. The additional information can further include physical aspects of the location (such as square footage, adjoining parking, etc.), goods and services offered, hours of operation, average number of employees, age of location, etc. Other information relating to a certain merchant or an associated vertical 173 can also be displayed, such as information sourced from external data sources 130, including third party customer review sites.

Demand display 216 can include one or more interactive graphical user interfaces that display demand conditions within and across channels 170. In certain embodiments, the demand display 216 can represent an overlay to the map that is presented in the channel display 212, which includes annotations identifying or visualizing the demand predictions generated by the geolocation analytics platform 150. In certain embodiments, users can select different channels 170 to view demand predictions 513 associated with the channel 170, each vertical 173 in the channel 170, each merchant in the channel 170, and/or specific inventory items (e.g., products and/or services) offered in the channel 170. For a selected channel 170, the demand predictions for a given vertical 173, and/or a particular inventory item offered by in that vertical 173, can be generated based on any combination of population density metrics 511, vertical density metrics 514, and any other metrics or predictions associated with other analytics displays 210. Additionally, as explained in further detail below, a machine learning network 160 may be utilized to generate some or all of the demand predictions 513.

The demand display 216 can provide both real-time and historical demand predictions for a selected channel 170, specific verticals in the channel 170, specific inventory items offered in the 170, and/or specific merchants located in the channel 170. The demand display 216 can also display demand predictions 513 for future time periods, for example, based on a date or time specified by the user or a date or time selected by the geolocation analytics platform 150 based on certain preexisting settings or factors.

Vertical density display 218 can include one or more interactive graphical user interfaces that display or visualize the vertical density metrics 514 for each vertical in a selected channel 170 (e.g., indicating a number of individuals in each of the verticals 173). In certain embodiments, the vertical density display 218 can represent an overlay to the map that is presented in the channel display 212. For example, in certain embodiments, users can select a particular channel 170 to view vertical density metrics associated with one or more verticals 173 in the channel 170. The vertical density display 218 can provide real-time vertical density metrics 514 relating to a current or most recent time period, and historical vertical density metrics (such as vertical density metrics generated for previous time periods). The vertical density display 218 can also display predicted vertical density metrics 514 for each of the verticals 173 in a selected channel 170 for a time period in future time periods, for example, based on a date or time chosen by the user or a date or time selected by the geolocation analytics platform 150 based on certain preexisting settings or factors.

Vertical density display 218 also can display other data related to a vertical 173 within a selected channel 170. Users can select a vertical 173 within a channel 170 to display vertical analytics metrics, which includes additional information related to the selected vertical 173 (e.g., identifying the type of vertical, merchants associated with the vertical, how many merchants are included in the vertical, etc.).

Population density display 220 can include one or more interactive graphical user interfaces that display or visualize the population density metrics 511 across the channels 170. In certain embodiments, the vertical density display 218 can represent an overlay to the map that is presented in the channel display 212. For example, in some embodiments, users can select a particular channel 170 to view population density metrics associated with that channel 170 and/or regions within the selected channel 170. The population density display 220 can provide historical population density metrics (such as population density metrics generated for previous time periods) in a selected channel 170 and/or it can provide population density metrics related to a selected channel 170 for the present time period. The population density display 220 also can display predicted population density metrics for a selected channel 170 in a future time period, for example, based on a date or time chosen by the user or a date or time selected by the geolocation analytics platform 150 based on certain preexisting settings or factors.

The data processed to calculate the population density metrics includes data related to location information corresponding to individuals, which can be obtained from an external data source 130, such as a cellular provider, and/or directly from the mobile devices 110 of the individuals.

Individual analytics display 224 can include one or more interactive graphical user interfaces that display or visualize various metrics associated with individuals (e.g., such as individuals located in the channels 170). The individual analytics display 224 can display any information collected or stored by the geolocation analytics platform 150 relating to individuals located within the channels 170. In certain embodiments, the geolocation analytics platform 150 can generate and store profiles for the individuals, that can be selected for viewing. For each individual, the profile can include data such as: current and/or historical location tracking data for the individual; vertical interaction data (such as data related to past purchases in specific verticals, visitations of merchant locations associated with certain verticals, or other interactions with verticals 173); and/or estimates of the individual's propensity or likelihood of visiting or interacting with each of a plurality verticals 173 (e.g., visiting a merchant location associated with the vertical and/or purchasing a certain good or service at a vertical 173 within a given time period in the future). The individual analytics display 224 can show historical data related to the various individual metrics for a given individual and current or near real-time metrics for the individual. The individual analytics display 224 can also show predictions made by the geolocation analytics platform 150 for the selected individual as part of, or separate from, the individual's profile.

User sourced data display 226 can include one or more interactive graphical user interfaces that display or visualize various metrics relating to user-sourced data. Examples of user sourced data include demographic data, psychographic data, preference data, transaction data, and feedback data. In some embodiments, this user sourced data can be collected through an individual's computing device 110 (e.g. mobile device), for example through an application related to a vertical 173 operating on the user's device. Alternatively, or in addition, user sourced data can be collected from external data sources 130, such as social media networks, review sites, marketing sites, etc.

Movement tracking display 228 can include one or more interactive graphical user interfaces that display or visualize data related to tracking movements of individuals within channels (intra-channel movements) and across channels (inter-channel movements). In certain embodiments, the movement tracking display 228 can represent an overlay to the map that is presented in the channel display 212, which displays annotations relating to movements of individuals. In certain embodiments, users can select a channel or channels 170 to view movement tracking metrics 512. The movement tracking display 228 can display historical movement tracking metrics, real-time or near real-time movement tracking metrics, or movement tracking metrics predicted for a given date or time in the future.

Member reward display 230 can include one or more interactive graphical user interfaces that display or visualize metrics relating rewards and incentives programs offered for a selected vertical 173 in a given channel 170 or in which a selected individual participates. The member reward display 230 can show the history of a given individual's participation in the reward program, including length of enrollment, activity, redemptions, etc. For a selected vertical 173 or merchant, the member reward display 230 can display summaries of reward program such as number of individuals enrolled, aggregate number of redemptions, aggregate activity over the period of the program, etc. The member reward display 230 can also show estimates of future activity in the enrollment program, such as an estimate of the number of redemptions over a given time period in the future.

Propensity prediction display 232 can include one or more interactive graphical user interfaces that display or visualize propensity prediction metrics for an individual located in a channel 170. The propensity prediction display 232 can display various propensity predictions with respect to selected verticals 173. A user can select the individuals, the verticals 173 for which the propensity will be calculated, and the time frame of interest for the propensity prediction, including from the present into some time in the future. Alternatively, or in addition, some or all of these constraints may be preset in the analytics dashboard 165. In certain embodiments, the propensity prediction display 232 can show aggregate propensity prediction metrics, such as the aggregate propensity that a certain group of individuals, for example a group sharing certain demographic characteristics, visits or makes a transaction with a selected merchant or vertical 173 within a certain period of time in the future. In some cases, the propensity prediction display 232 can be part of, or provided in connection with, the individual analytics display 224.

The analytics dashboard 165 also includes a configuration display 250. The configuration display 250 can include one or more interactive graphical user interfaces that permits user to configure settings for executing deployment functions 190. For example, the configuration display 250 can include a client system interface display 252 that enables a user to interface or connect one or more client systems 140 with the geolocation analytics platform 150. The client system interface display 252 can include graphical user interfaces that establishes communications between the one or more client systems and the geolocation analytics platform 150 via an application programming interface (API) provided by the geolocation analytics platform 150. After a client system 140 is interfaced with the geolocation analytics platform 150, the client system 140 can receive and utilize the channel analysis data 180 (and any other information) generated by the geolocation analytics platform 150.

The configuration display 250 also can include a notification configuration display 254 that permits users to specify settings for sending notifications. For example, a user can specify the content of notifications (e.g., by specifying channel analysis data 180 for specific channels and/or verticals to be included in the notifications). The user also can specify how the notifications are be transmitted (e.g., via e-mail, cellular text messages, inbox messages on platform user accounts, data presented on the analytics dashboard 165, etc.) and where the notifications are to be transmitted various devices (e.g., client systems 140, mobile or computing devices operated by individuals located in a channel 170, etc.). Additionally, the user can specify how frequently notifications should be sent (e.g., daily, weekly, etc.). In some embodiments, user also can specify triggering events that will initiate the automatic transmission of notifications in response to the geolocation analytics platform 150 detecting certain conditions in designated channels 170. For example, a user may set triggering events that indicate notifications should be transmitted when the demand and/or population density in a particular channel or in a particular vertical in the channel exceeds a specified value or threshold.

The analytics dashboard 165 also can include one or more client application plug-ins 240. The client application plug-ins 240 provide interoperability between the various client applications and the geolocation analytics platform 150. In certain embodiments, through the client application plug-in 240, the analytics dashboard 165 can display data from the client application directly on the analytics dashboard 165. Through the client application plug-in 240, the user can determine which data from the client application is available to the geolocation analytics platform 150, for example, for use in generating channel analysis data 180.

The analytics dashboard also includes input options 270 and display options 260. The input options 270 can include any method or system capable of inputting data or commands into the geolocation analytics platform 150 or controlling or customizing the analytics dashboard 165. The display options 260 can include any type of display or output system for presenting the data stored on the analytics platform to the user. Both the input options 270 and the display options 260 are discussed in more detail in FIGS. 5D and 5C below.

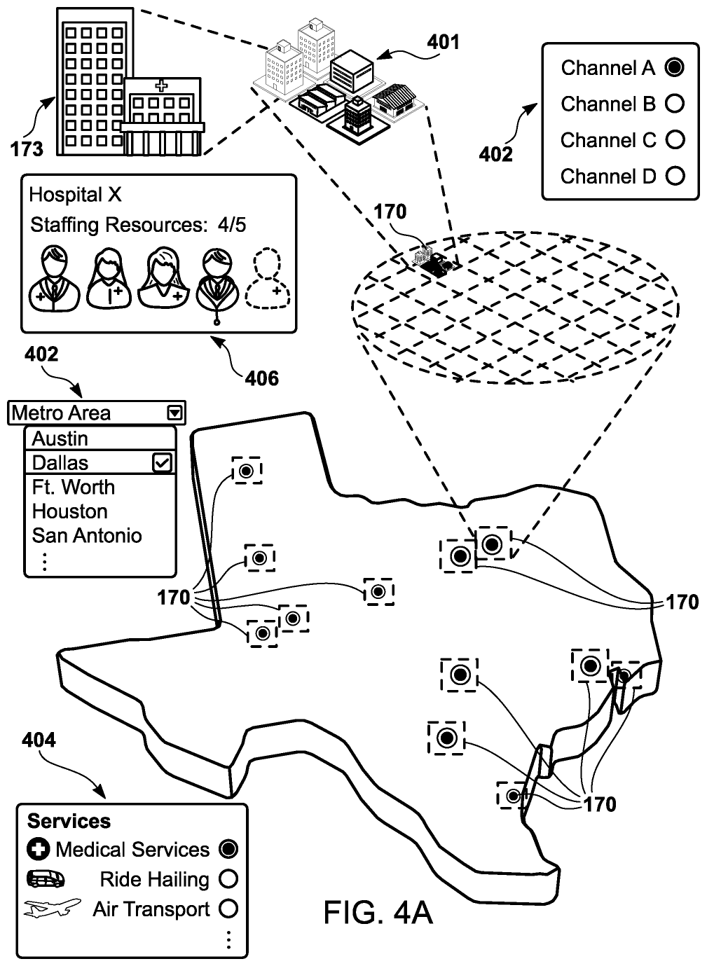

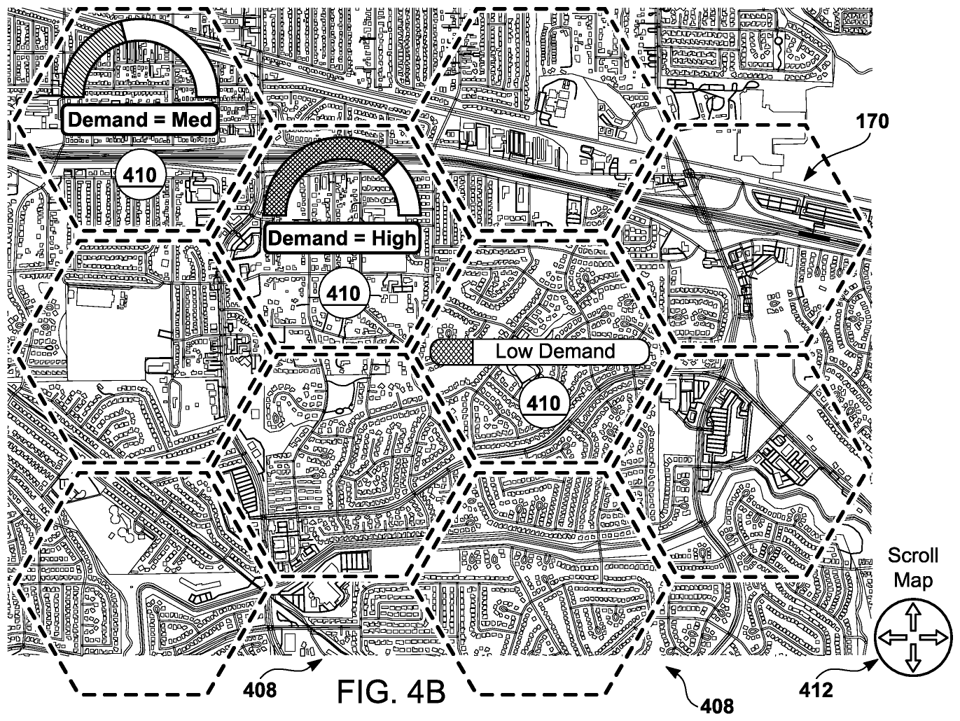

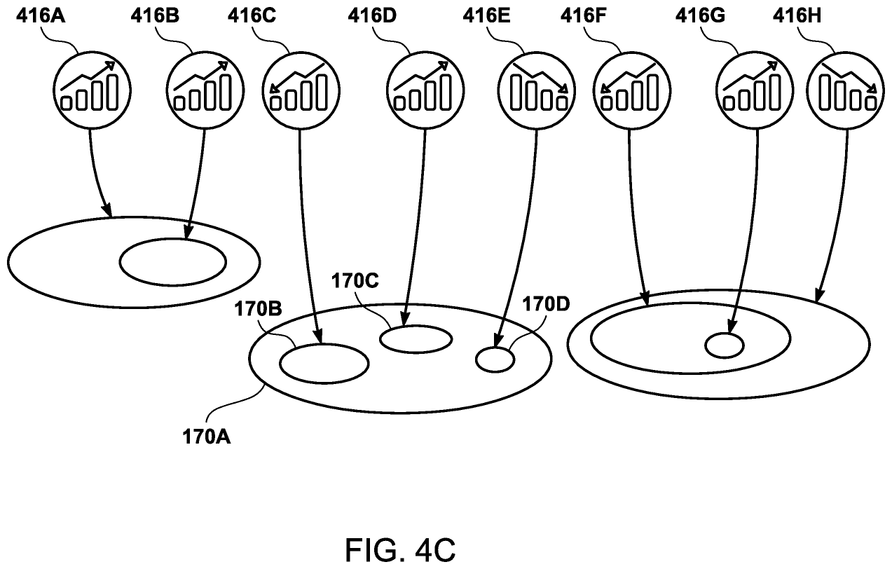

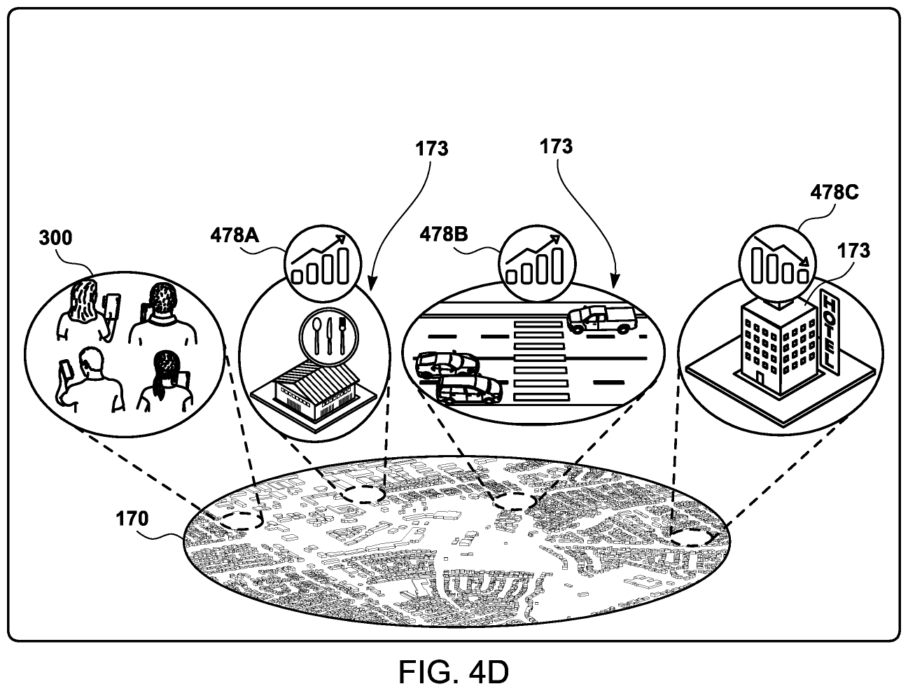

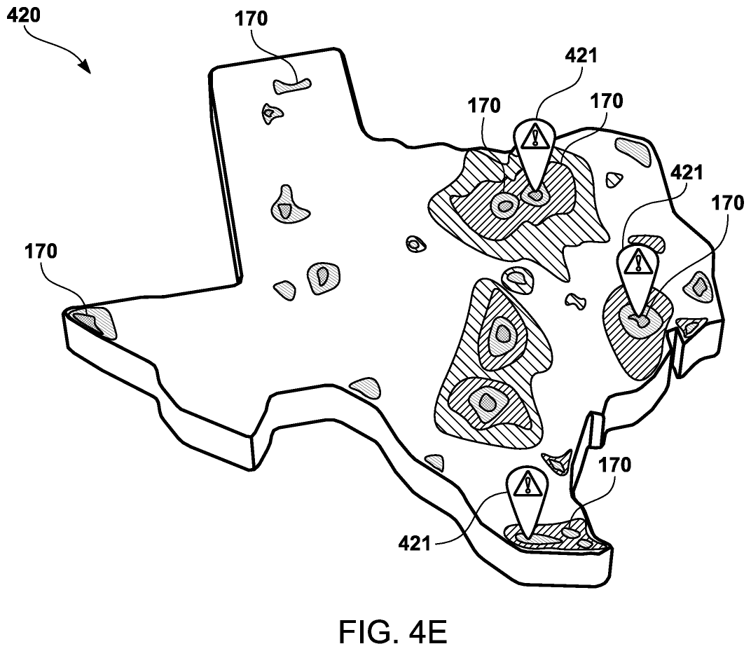

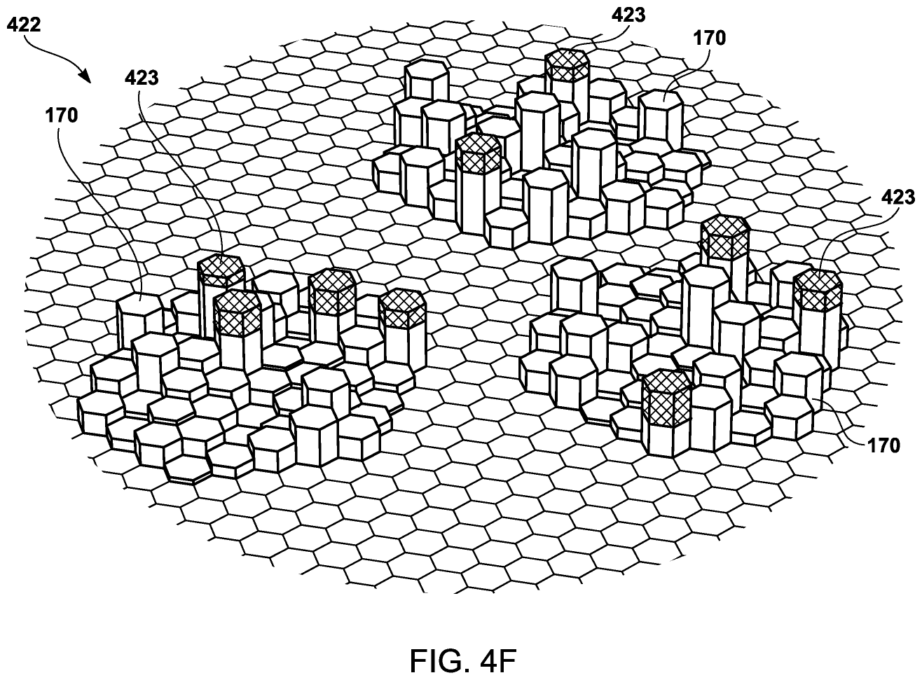

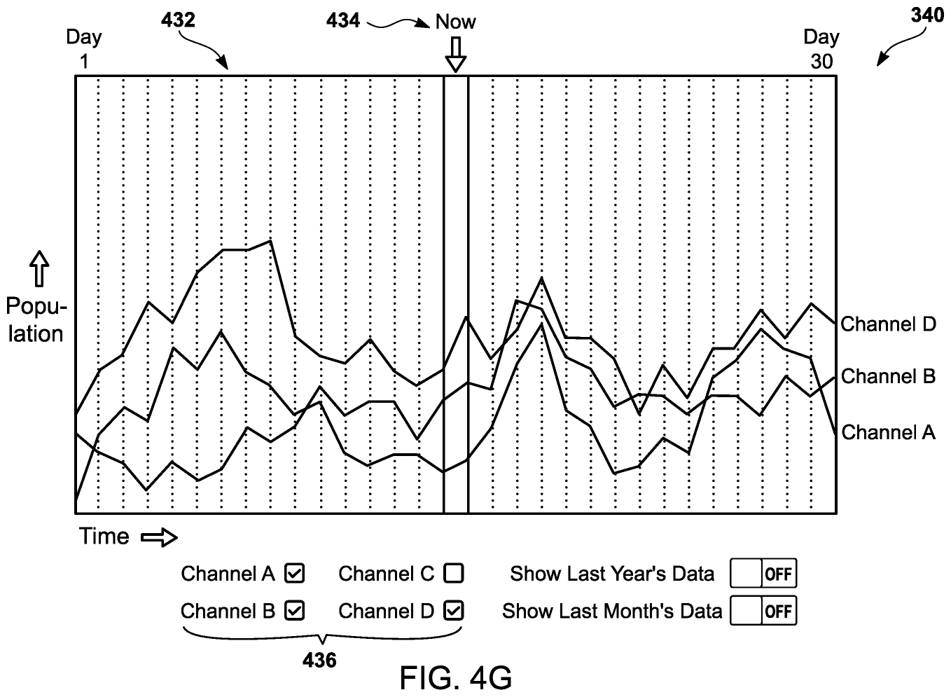

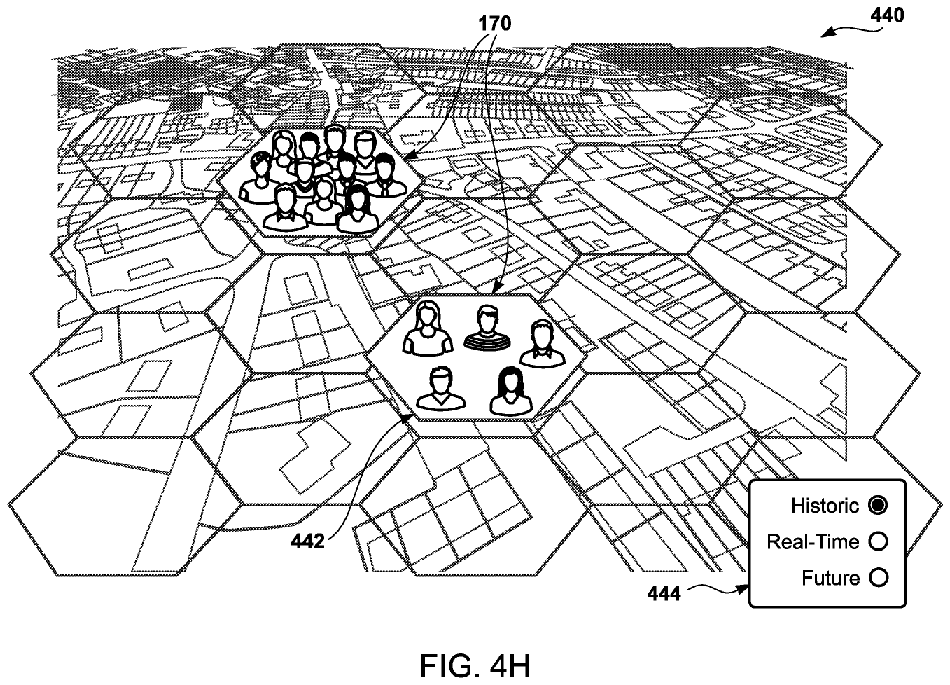

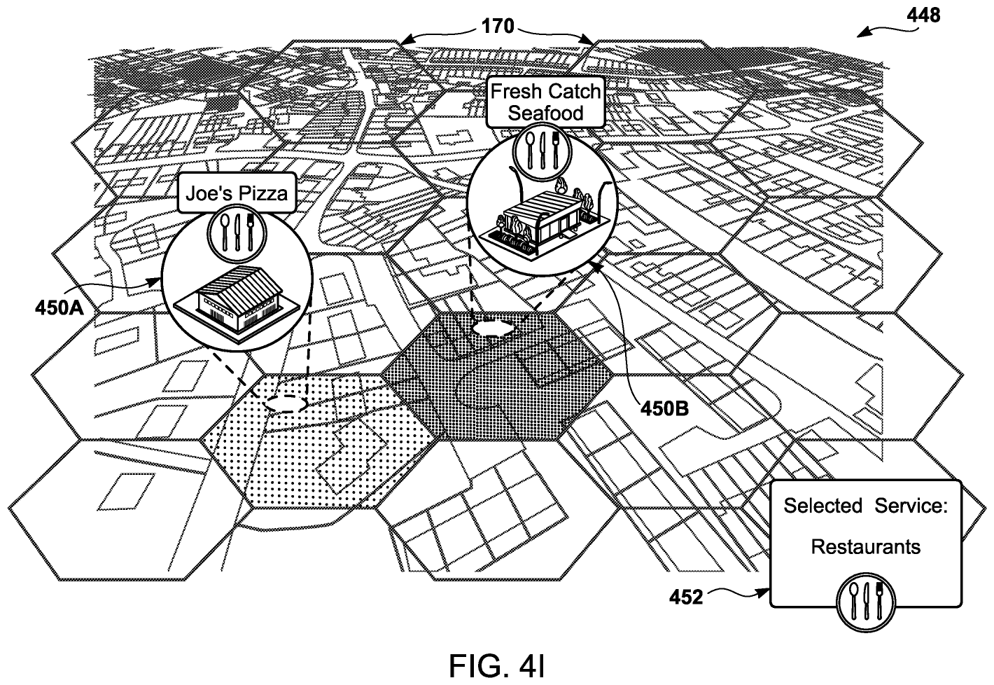

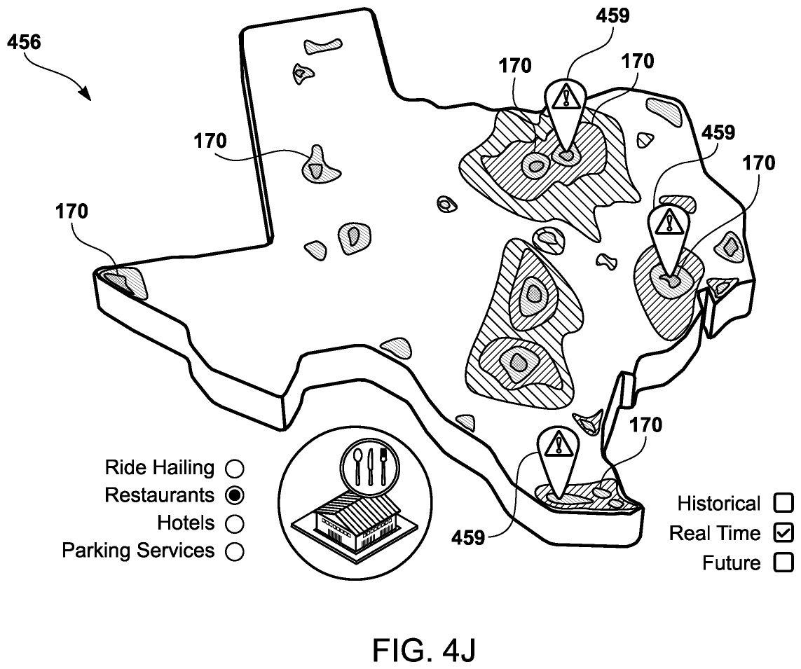

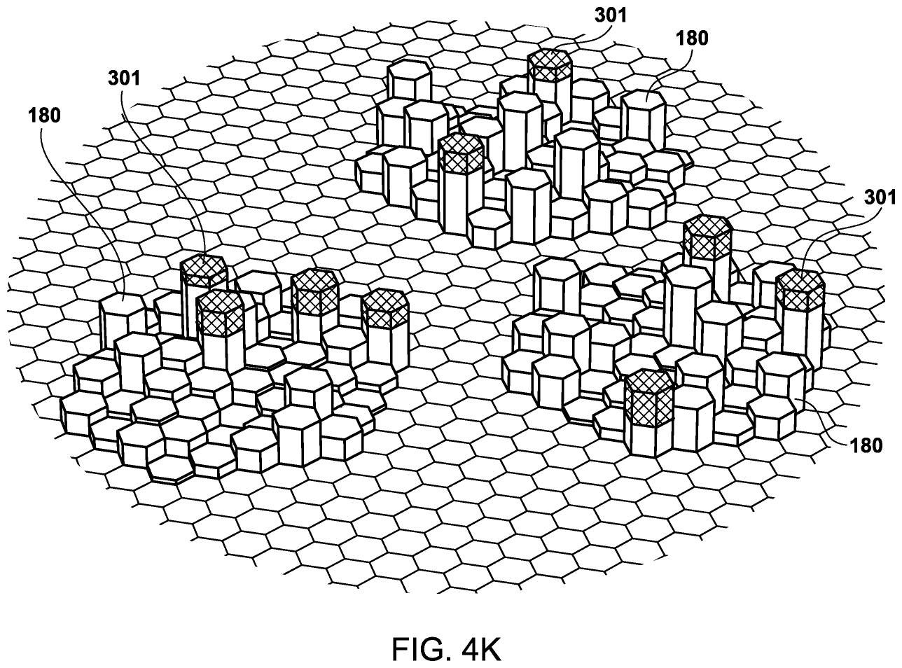

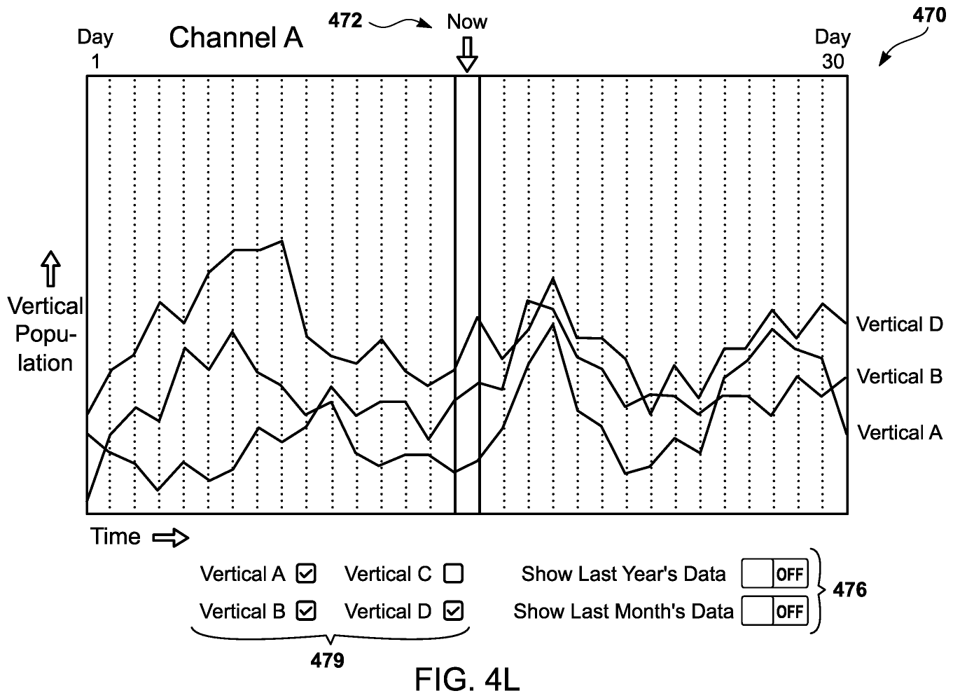

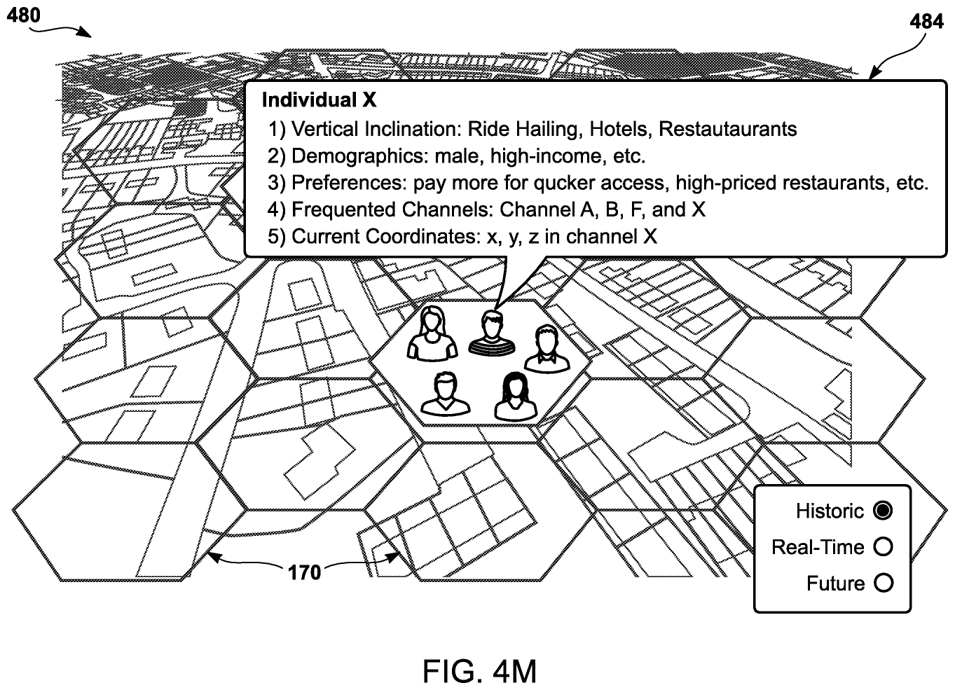

FIGS. 4A-4M illustrate exemplary graphical user interfaces (GUIs), or portions thereof, that can be displayed in connection with the analytics dashboard 165 in accordance with certain embodiments. As explained thought this disclosure, the geolocation analytics platform 150 can collect and monitor channel events 175 related to demand conditions across a plurality of channels 170 corresponding to geographic regions, and a channel analysis function 166 can utilize the channel events 175 to derive channel analysis data 180 corresponding to each of the channels 170. The graphical user interfaces illustrated in FIGS. 4A-4M demonstrate how the analytics dashboard 165 can visualize, and facilitate user interactivity with, the channel analysis data 180 in a user-friendly and intuitive manner.

While the interfaces, displays, and interactive features described below demonstrate examples of how the channel analysis data 180 can be presented and displayed by the analytics dashboard 165, it should be understood that various modifications can be made. Amongst other things, any data or visualizations illustrated for one interface can be combined with, or incorporated into any other interface described in this disclosure. Additionally, certain features or options illustrated in the interfaces can be modified or omitted in certain cases. Additionally, while certain displays (e.g., channel display 212, merchant display 214, demand display 216) may be described as being separate components in some cases, it should be recognized that this distinction may be made for purposes of clarity and that a single display can be configured to generate any or all of the mentioned displays.

Additionally, certain portions of the disclosure describe selections being made via the interfaces in FIGS. 4A-4M. It should be understood that selection can be made using any known selection mechanism or technique. For example, receiving a selection may include receiving an input via a cursor, mouse click, and/or gesture in some cases. Additionally, in certain cases, selections or inputs may be described as being received via a particular input option (e.g., text box, checkbox, radio button, drop-down menus, etc.). However, it should be understood that any input option can additionally, or alternatively, be utilized to receive inputs.

FIG. 4A is an exemplary graphical user interface that includes an interactive channel map 401, which can be generated and presented in connection with the channel display 212 of the analytics dashboard 165 according to certain embodiments. In this example, the interactive channel map 401 is displaying a channel 170 that corresponds to the State of Texas, and it displays a plurality of sub-channels 170 within the region. The user may also zoom in and zoom out of the interactive channel map 401 or scroll the interactive channel map 401 up and down, left and right, to bring portions of it into the viewable area of the channel display 212. Additionally, a user can utilize the interactive channel map 401 to navigate to other channels 170 or regions (e.g., channels 170 corresponding to other different states, citifies, or regions).

The channel display 212 generates an overlay that displays boundaries associated with the channels 170. The interactive channel map 401 can be configured to enable selection of the channels 170. For example, a user can select a channel 170 directly via the interactive channel map 401 (e.g., by clicking on the desired region displayed on the map). Additionally, or alternatively, a user can select a channel 170 via a menu 402 that provides a listing of channels 170. In some embodiments, selecting one of the channels 170 displayed in the interactive channel map 401 can cause the channel display 212 to zoom in on the selected region and/or display data and options associated with the selected region. For example, select a channel 170 can display various types of channel analysis data 180 (e.g., demand metrics, population density metrics, vertical density metrics, etc.) corresponding to the selected channel 170.

Additionally, the channel display 212 can present input options that permit a user to filter the interactive channel map 401 by verticals 173. For example, a vertical 173 may be selected from a menu 404 by selecting an option (e.g., radio button) next to the vertical name or description. Selecting a vertical 173 can cause the channel display 212 to present channel analysis data 180 that is specific to the selected vertical 173 (e.g., demand metrics specific to the vertical in each channel, vertical density information in each of channels, etc.).

Additionally, in some embodiments, the channel display 212 may further include selection options that enable a user to select a particular merchant location associated with the selected vertical. Information related to the selected merchant location may then be displayed in a separate location window 406 and can include any information collected by the geolocation analytics platform 150 related to that location (e.g., the location name, products and services offered, etc.). In certain embodiments, information in the location window 406 can be edited or updated by the user.

FIG. 4B is a graphical user interface that includes an interactive demand map 408, which can be generated and presented in connection with a demand display 216 on the analytics dashboard 165 according to certain embodiments. As shown, boundaries of multiple channels 170 are superimposed over a geographical area. The user can navigate around the demand map 408 to view different portions of the demand map 408 by using the scroll map buttons 412. The user also can zoom in and zoom out of different portions of the demand map 408. In certain embodiments, some or all of the channels 170 displayed on the demand map 408 can be annotated with demand indicators 410 that indicate or display the demand for a specific vertical and/or inventory item 335 in the given channel. These demand indicators 410 can visually display the demand predictions generated by the geolocation analytics platform 150. The demand indicators 410 can display predictions of demand for particular channels at some point in time (e.g., a time period in the past, a current time period, and/or a future time period) based selections made by the user.

It should be recognized that the demand display 216 can visualize or display the demand using other techniques as well. For example, in some cases, heat maps may be presented that display the display the demand in a region or channel. Additionally, the demand for each channel can be displayed using graphs, charts, and other visual representations.

FIG. 4C is another exemplary graphical user interface that can be generated by the demand display 216, which indicates or visualizes the demand predictions for channels 170 using graphs and/or charts according to certain embodiments. The graphs and/or charts generated by the analytics dashboard 165 can display demand in particular channels 170A-170D for a particular vertical 173 or a particular inventory item 335 in the channel over a particular time period (e.g., in some cases, a time period spanning the past, present, and/or future). As shown, the demand for a particular vertical 173 or inventory item 335 can be represented using demand indicators 416A-H. In some embodiments, the demand indicators can be annotated with trend indicators (e.g., upward or downward arrows) to indicate the how the demand is currently trending. A user can select the demand indicators 416A-H to view additional details. For example, in some cases, selection of the demand indicators 416A-H can enable the user to view graphs, charts, or the like illustrating the demand for the channel over a period of time.

FIG. 4D is another exemplary graphical user interface that can be generated by the demand display 216 according to certain embodiments. The user interface of the analytics dashboard 165 includes a user-selectable map displaying a selected channel 170. Different regions of the channel 170 and different verticals 173 or merchant locations associated with the verticals 173 can be selected. Once selected, the demand for a particular vertical 173, or inventory item offered in connection with the vertical 173 or associated merchant location, can be represented (e.g., using the demand indicators 418A-C with an arrow trend line). In some embodiments, the analytics dashboard 165 can display demand for these particular verticals 173 or locations over a period of time selected by the user (e.g., a time period in the past, a current time period, and/or a future time period). Icons representing certain verticals 173 can also be shown on the user interface. In certain embodiments, these icons can be selected, which can then cause the interface to be updated to display additional information related to the vertical 173.

FIG. 4E is an exemplary graphical user interface that includes an interactive population map 420 that can be generated by a population density display 220 according to certain embodiments. In this example, the interactive population map 420 visualizes the population density metrics for a channel 170 (and associated sub-channel 170) using a heat map. The different population densities for each of the channels 170 is represented by a difference in pattern, with tighter patterns signifying higher population densities for that channel. Alternatively, or in addition, the population densities for each channel 170 can be represented by different colors and include a key to correlate the color for each channel to population density. The interactive population map 420 can represent the population density metrics for a channel or multiple channels in real-time, at a time in the past, or at some point in the future. The interactive population map 420 can be configured to enable selection of the channels 170 and/or sub-channels 170.

The interactive population map 420 also can display population density alerts 421 indicating locations where the population density in a certain channel 170 at a given time reaches a certain threshold. The threshold can be set by the user or determined by the geolocation analytics platform 150. In certain embodiments, the interactive population map 420 can display additional information related to the population density alert 421 when the user selects the notification icon (e.g., a predicted number of individuals in each region and/or demand predictions derived, at least in part, on the population density information).

FIG. 4F is an alternative interactive population map 422 of a population density display 220 in an exemplary graphical user interface of an analytics dashboard 165 according to certain embodiments. The alternative interactive population map 422 includes selectable regions, each of which can correspond to a separate channel 170. The different population densities for each of the channels 170 is represented by a difference in height, with a higher bar signifying a higher population density for that channel. The interactive population map 422 can represent the population density display 220 based on a time period selected by the user (e.g., a time period in the past, a current time period, and/or a future time period).

The interactive population map 422 can also display population density alerts 423 when the population density in a certain channel 170 reaches a certain threshold. The threshold can be set by the user or by the geolocation analytics platform 150. In certain embodiments, the interactive population map 422 can display additional information related to the population density alerts 423 when the user selects the channel.

FIG. 4G is a population density graph 432 that can be accessed via the population density display 220 according to certain embodiments. The population density graph 432 is a line graph representing the population within three separate channels—A, B, and D (based on selections of channel options 436 presented a menu below the graph). The population density within each channel 170 is measured on the y-axis of the population density graph 432, while time is measured on the x-axis. The y-axis can be denominated using numbers (e.g., indicating a number of people in a given channel) or a ratio of number of people in a given standard area (e.g., 1000 persons per square kilometer). Time can be measured on the x-axis in any unit including seconds, minutes, hours, days, months, or years. In certain embodiments, the scale and the range of y-axis and the x-axis can be changed by either the user or the geolocation analytics platform 150. For example, the x-axis can be customized to display a full hour, a full day, a full week, or a full month, etc. (or any portion thereof) based on user preferences or selections. The range of the y-axis can also be customized to show any range of numbers to capture the fluctuations of population and/or population density over time for the selected channels.

The population density graph 432 can also include a present time indicator 434 to identify which point on the x-axis reflects the current or most recent time period. Historical data related to population and/or population density can be displayed to the left of the present time indicator 434 on the population density graph 432 and estimates of population and/or population density for the selected channel(s) can be displayed to the right of the present time indicator 434 on the population density graph 432. In certain embodiments, the analytics dashboard display 340 includes one or more channel options 436 (e.g., check boxes or other selectable options) for selecting the channel(s) to be displayed on the population density graph 432. The analytics dashboard display 340 also can include selectable sliders for overlaying data from a historical or future time period. Moreover, portions of the population density graph 432 can be selectable by a cursor, allowing the user to scroll the population density graph 432 left or right or zoom in or zoom out of certain sections of the graph. The lines that chart the population and/or population density for each of the channels 170 also can be selectable. When a certain portion a line is selected, the analytics dashboard display 340 can display additional statistics relating to the channel 170 at that point in time. The additional statistics can be displayed as an overlay window on the population density graph 432 or in a separate window positioned elsewhere on the analytics dashboard display 340.

FIG. 4H is a graphical user interface displaying an interactive movement tracking map 440 that visualizes or displays movement tracking metrics, which can be generated and displayed by the movement tracking display 228 via the analytics dashboard 165 according to certain embodiments. The interactive movement tracking map 440 can show movements or migrations of individuals (or groups of individuals) within and throughout the channels.

The interactive movement tracking map 440 includes selectable regions which correspond to channels 170. In some cases, selection of a channel 170 may cause the movement tracking display 228 to zoom into a channel 170 and provide more granular information related to the movement tracking metrics associated with the selected channel 170. Additionally, some of the channels 170 can be annotated with one or more icons 442 representing one or more individuals located in the channel 170. In some cases, the individual icons 442 may identify channels where significant portions individuals are migrating or gathering.

The interactive movement tracking map 440 can represent the movement tracking metrics in real-time, at a time in the past, or at some point in the future.

The user can toggle between time periods shown by the movement tracking display 228 in the interactive movement tracking map 440 by using the options on the menu of selectable time periods 444.

FIG. 4I is a graphical user interface that includes a merchant interactive map 448, which can be generated and displayed by a merchant display 214 via the analytics dashboard 165 according to certain embodiments. In certain embodiments, the merchant display 214 can represent an overlay to the map that is presented in the channel display 212, which includes annotations identifying or visualizing the merchant locations in a selected vertical (e.g., in this case, for a restaurant vertical). Each of the channels 170, or portions thereof, can be annotated with one or more merchant icons 450A-B representing one or more merchants located in the channels 170. The vertical 173 shown by the merchant display 214 is identified in the vertical legend 452 in the merchant interactive map 448. The vertical 173 displayed in the merchant interactive map 448 can be set or changed by the user. Additionally, the channels 170 can be configured to be selectable, such that selection of channel 170 causes the merchant display 214 to zoom in on the channel and display more granular merchant information associated with the selected channel 170.

FIG. 4J is a graphical user interface that includes an interactive vertical density map 456, which can be generated and displayed by a vertical density display 218 via the analytics dashboard 165 according to certain embodiments. The vertical density interactive map 456 visualizes and displays the vertical density metrics for one or more channels 170 that are presented on the vertical density display 218. The user can select a vertical 173 of interest (e.g., using the menu options shown) to view the vertical density metrics corresponding to the selected vertical. In this example, the “restaurants” option is selected and the map is displaying vertical density metrics associated with the restaurant vertical in each of the channels 170. The vertical density interactive map 456 includes selectable regions which correspond to channels 170. The vertical density metrics for the channels 170 can be represented using a heat map that visualizes the vertical density for each of the channels 170. For example, the channels 170 can be shaded or colored to represent the population density within the channel 170 with respect to the selected vertical 173. The vertical density interactive map 456 can represent the vertical density display 218 in real-time, at a time in the past, or at some point in the future. The user can toggle between time periods shown by the vertical density display 218 in the vertical density interactive map 456 by using menu options with selectable time periods.

The vertical density interactive map 456 can also display vertical density notifications 459 when the vertical density in a certain channel 170 reaches a certain threshold. The threshold can be set by the user or by the geolocation analytics platform 150. In certain embodiments, the user can select a channel 170 and/or vertical density notification 459 to obtain more granular information related to the vertical density metrics.

FIG. 4K is an alternative version of a vertical density interactive map 456 of a vertical density display 218 for the analytics dashboard 165 according to certain embodiments. The vertical density interactive map 456 includes selectable regions corresponding to channels 170. The vertical density interactive map 456 can visualize or display the vertical density for each of the channels 170 by adjusting the height of a bar extending from each channel 170. For example, the higher the bar extending upwards from the channel 170, the higher the density metric for the selected vertical 173.

The vertical density interactive map 456 can also display vertical density notifications 459 indicating when the vertical density in a certain channel 170 reaches a certain threshold. The vertical density notification 459 can be displayed to the user by texturing or shading certain portions of the bar extending from the channel 170. The threshold can be set by the user or by the geolocation analytics platform 150. In certain embodiments, the user can select the channels 170 and/or vertical density notifications 459 to view more granular information related to the vertical density metrics.

FIG. 4L is a vertical density graph 470 that can be generated by a vertical density display 218 according to certain embodiments. The vertical density graph 470 is a line graph representing the vertical densities for selected verticals (e.g., in this example, verticals A, B, and D) within a given channel 170. The population within each vertical is measured on the y-axis of the vertical density graph 470 while time is measured on the x-axis. Time can be measured on the x-axis in any unit including seconds, minutes, hours, days, months, or years. In certain embodiments, the scale and the range of y-axis and the x-axis can be changed by either the user or the geolocation analytics platform 150. For example, the x-axis can display vertical density information for a previous time period, a current time period, and/or a future time period. The range of the y-axis can also be customized to show any range of numbers to capture the fluctuations of population over time for the selected verticals 173.

The vertical density graph 470 can also include a present time indicator 472 to identify which point on the x-axis reflects the current time period. Historical data related to population can be displayed to the left of the present time indicator 472 on the vertical density graph 470 and estimates of population for the selected vertical(s) can be displayed to the right of the present time indicator 472 on the vertical density graph 470. In certain embodiments, the analytics dashboard display 340 includes one or more vertical options 479 that enable the user to select the verticals to be displayed on the vertical density graph 470. The analytics dashboard display 340 can also include options 476 for viewing the graph with data from certain historical time periods. The lines that chart the population for each of the verticals 173 selected also can be selectable. When a certain portion a line is selected, the analytics dashboard display 340 can display additional statistics relating to the vertical 173 at that point in time. The additional statistics can be displayed as an overlay window on the vertical density graph 470 or in a separate window positioned elsewhere on the analytics dashboard display 340.

FIG. 4M is an interactive individual profile map 480 that can be generated by an individual analytics display 224 according to certain embodiments. The interactive individual profile map 480 enables a user to view granular, individualized profiles 484 associated with individuals located in the channels 170. A user can select a channel 170 to view one or more individuals located in the channel 170, and the user can select specific individuals to view corresponding profiles. Amongst other things, the individual profile 484 for each individual can display information relating vertical propensity predictions (e.g., indicating which verticals the user is likely to engage and/or has commonly engaged in the past), demographics, service or purchase preferences, channels frequently visited by the individual, and the current location of the individual.

While FIGS. 4A-4M illustrate exemplary interfaces or displays that can be generated by, and accessed through, the analytics dashboard 165, it should be understood that the data presented on these interfaces or displays can be presented in many other ways and the analytics dashboard 165 can be configured to generate a variety of additional information to display the channel analysis data 180.

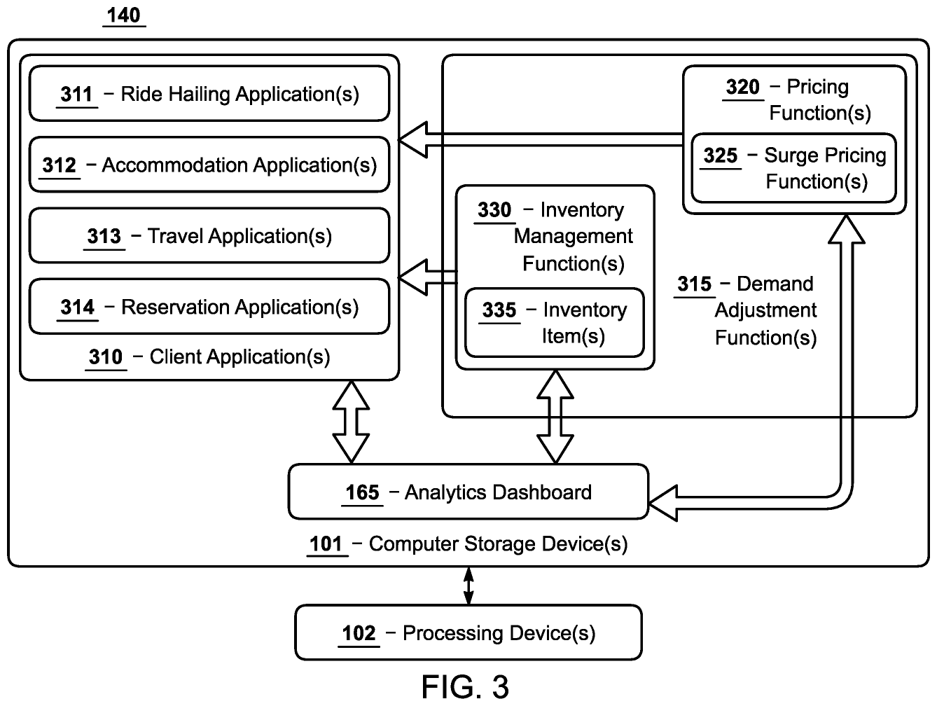

FIG. 3 is a block diagram exemplary features, components, and/or functions of a client system 140 according to certain embodiments. The client system 140 can include one or computing devices 110 and/or one or more servers 120, each of which includes one or more computer storage devices 101 and one or more processing devices 102. The client system 140 can host and execute one or more client applications 310. In certain embodiments, client system 140 also can host and execute the analytics dashboard 165 (rather than, or in addition to, the geolocation analytics platform 150).

Exemplary client applications 310 provided by a client system 140 can include one or more of the following: 1) a ride hailing application 311 (e.g., an application that connects passengers with drivers to schedule rides); 2) an accommodation application 312 (e.g., an application that permits guests to schedule rooms or lodging); 3) a travel application 313 (e.g., an application that permits individuals to book schedule transportation with airlines, trains, buses, boats, etc.); and 4) a reservation application 314 (e.g., an application that permits individuals to schedule reservations or tickets for restaurants, concerts, events, bars, parking spaces, and/or other venues). Other types of client applications 310 also may be hosted and executed by the client systems 140. In certain embodiments, the client applications 310 can represent web-based applications that are accessible via a web browser and/or local applications (e.g., mobile apps) that are installed on devices (e.g., mobile devices or smart phones) operated by end-users.

The channel analysis data 180 (such as the movement tracking metrics and demand predictions, etc. described in more detail in FIG. 5B below) can be utilized to enhance various functionalities of the client applications 310. In some scenarios, the channel analysis data 180 can be utilized to enhance or implement one or more demand adjustment functions 315, such as a pricing function 320 and/or an inventory management function 330, for each of the client applications 310. These demand adjustment functions 315 can be executed by the client system 140 in some cases, and can be executed by the geolocation analytics platform 150 in other cases. The demand adjustment functions 315 can be configured to adjust pricing and/or inventory information for inventory items based on actual or predicted supply metrics and/or demand metrics for the inventory items. The pricing function 320 and/or inventory management function 330 can be included within the functionality of each of the client applications 310, or can be included in separate applications that communicate with the client applications 310.

As explained above, the analytics dashboard 165 can provide various interfaces that visualize the channel analysis data 180 and other data generated by the geolocation analytics platform 150. In certain embodiments, the analytics dashboard 165 can communicate with the client systems 140 (e.g., using interfacing functions 192, client application plug-ins 240 and/or by other means) to enable the client applications 310 to access and utilize the data generated by the geolocation analytics platform 150. The analytics dashboard 165 can display data received from the demand adjustment functions 315 and the client applications 310 (e.g., data related to pricing and/or inventory). In some cases, analytics dashboard 165 also can receive commands from users to control both the client applications 310 and the demand adjustment functions 315. Additionally, as shown in FIG. 3, in some cases, the analytics dashboard 165 can be provided directly via the client systems 140.

The pricing function 320 can utilize the channel analysis data 180 to determine pricing for one or more inventory items 335, which may generally include any type of product or service made available by a client application 310. For example, depending on the functionality of a given client application 310, the pricing function 320 can determine pricing for ride hailing services, taxi services, lodging accommodations, event tickets (e.g., for sporting events or concerts), airline tickets, train tickets, packing spaces, etc.

In some scenarios, the channel analysis data 180 can be utilized to implement a surge pricing function 325 for one or more of the client applications 310. A surge pricing function 325 generally represents a function that adjusts the price of one or more inventory items 335 based on the demand for the inventory items 335 (e.g., based on a comparison of the supply and the demand for the inventory items 335). In certain embodiments, the channel analysis data 180 (e.g., the demand predictions 513) generated by the geolocation analytics platform 150 may be utilized to dynamically adjust the pricing of one or more inventory items 335 offered by each of the client applications 310.

The inventory management function 330 can utilize the channel analysis data 180 to manage or adjust inventory items 335 in various ways. For example, the inventory management function 330 can detect when additional inventory items 335 should be ordered to accommodate a current demand for inventory items 335 and/or a predicted future demand for inventory items 335. In some scenarios, the inventory management function 330 also can be configured to automatically place an order for additional inventory items 335 to accommodate a spike in a current or predicted demand for the inventory items 335.

The inventory management functions 330 can also communicate with the analytics dashboard 165. The inventory management function 330 may send the status of various inventory items 335 to the analytics dashboard 165. The inventory management function 330 can also send notifications to the analytics dashboard 165 to alert the user to place an order for one or more inventory items 335 or send a prediction of the demand for one or more inventory items 335. The user can manually place an order for an inventory item 335 through the analytics dashboard 165, which communicates that command to the inventory management function 330, or by responding to a notification relating to an inventory item 335 sent by the inventory management function 330.

The inventory management function 330 also can reallocate inventory items 335 to accommodate varying supply and demand metrics across different channels 170 and/or within a given channel 170. For example, in some scenarios, a merchant may have multiple business locations, including multiple locations within a given channel 170 and multiple locations situated outside the channel 170. The inventory management function 330 can utilize the channel analysis data 180 to dynamically reallocate inventory items 335 among the business locations in within the given channel 170 to accommodate the varying demands at those locations and/or to maximize sales of inventory items 335 across all locations. Similarly, the inventory management function 330 can utilize the channel analysis data 180 to dynamically reallocate inventory items 335 from a location in one channel 170 to one or more separate channels in order to accommodate the varying demands in each channel 170 and/or to maximize sales of inventory items 335 across all channels 170. Alternatively, or in addition, the inventory management function can prompt the user through the analytics dashboard 165 to reallocate one or more inventory items 335 between two or more business locations within a channel 170 or between separate channels. Through the analytics dashboard 165, the user can select the timing, means, and quantity of inventory items 335 to send between business locations.

In certain embodiments, the client applications 310 can additionally, or alternatively, be stored on and executed by the geolocation analytics platform 150. Similarly, the demand adjustment functions 315 (e.g., including the pricing function 30, the surge pricing function 325, and/or the inventory management function 330) can be stored on and executed by the geolocation analytics platform 150.

For example, in certain embodiments, geolocation analytics platform 150 can be directly integrated with a client system 140 and can execute the demand adjustment functions 315. For example, in addition to generating the channel analysis data 180, geolocation analytics platform 150 can execute one or more demand adjustment functions 315 for the channel 170. In one example, geolocation analytics platform 150 can execute a surge pricing function 325 that utilizes the channel analysis data (e.g., the population surge metrics and/or demand metrics) to dynamically adjust the pricing of one or more inventory items 335. In another example, geolocation analytics platform 150, or the machine learning network 160, can execute an inventory management function 330 that dynamically allocates or reallocates inventory items 335 within a channel 170 and/or among a plurality of channels 170.

In some embodiments, pricing function 320 can send the dynamically generated pricing for a given inventory item 335 to the analytics dashboard 165. The analytics dashboard 165 can display pricing information for the inventory item for a past time period and/or a current time period, and can predict or recommend pricing for a future time period. In addition, the user can manually adjust the pricing for an inventory item 335 through the analytics dashboard 165 if desired. For example, the user can increase or lower the price determined by the surge pricing function 325 that is outputted to the client applications 310 manually, either as a percentage of the price determined by the surge pricing function 325 or in absolute terms.

The user can also set parameters through the analytics dashboard display 340 for the demand adjustment functions 315 to model how changes in certain channel analysis data 180 would affect the output and behavior of these functions. For example, at some point in time, the user can select a value for certain channel analysis data 180 (such as population density metrics), to determine what dynamic pricing output would be set by the surge pricing function 325 for a given inventory item 335. The user can also select through the analytics dashboard display 340 a price for an inventory item 335 for a given point in time. That price can then inputted into the inventory management function 330 to determine how the inventory for that inventory item 335 would be affected if the price sent to the client application 310 was set at that point at that time. These prediction estimates supplied by the pricing functions 320 and/or the inventory management functions 330 based on different parameters set by the user through the analytics dashboard display 340 provide the user with a simulation of how the demand adjustment functions 315 would perform if certain channel analysis data 180 changes.

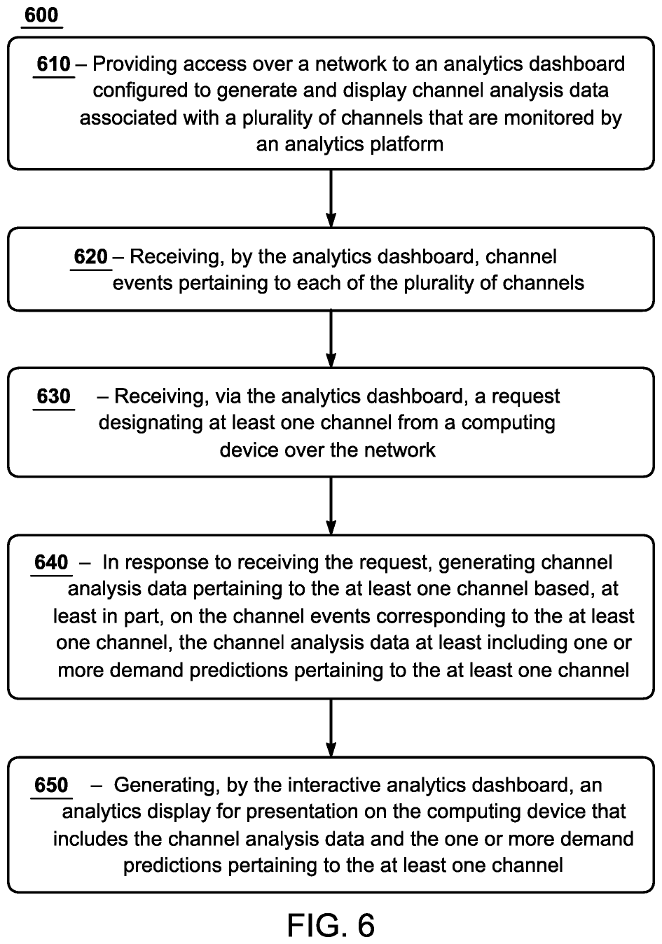

FIG. 6 illustrates a flow chart for an exemplary method 600 according to certain embodiments. Method 600 is merely exemplary and is not limited to the embodiments presented herein. Method 600 can be employed in many different embodiments or examples not specifically depicted or described herein. In some embodiments, the steps of method 600 can be performed in the order presented. In other embodiments, the steps of method 600 can be performed in any suitable order. In still other embodiments, one or more of the steps of method 600 can be combined or skipped. In many embodiments, system 100, geolocation analytics platform 150 can be configured to perform method 600 and/or one or more of the steps of method 600. In these or other embodiments, one or more of the steps of method 600 can be implemented as one or more computer instructions configured to run at one or more processing devices 102 and configured to be stored at one or more non-transitory computer storage devices 101. Such non-transitory memory storage devices 101 can be part of a computer system such as system 100 or geolocation analytics platform 150.

Step 610 includes providing access over a network to an analytics dashboard configured to generate and display channel analysis data associated with a plurality of channels that are monitored by an analytics platform.

Step 620 includes receiving, by the analytics dashboard, channel events pertaining to each of the plurality of channels.

Step 630 includes receiving, via the analytics dashboard, a request designating at least one channel from a computing device over the network.

Step 640 includes, in response to receiving the request, generating channel analysis data pertaining to the at least one channel based, at least in part, on the channel events corresponding to the at least one channel, the channel analysis data at least including one or more demand predictions pertaining to the at least one channel.

Step 650 includes generating, by the interactive analytics dashboard, an analytics display for presentation on the computing device that includes the channel analysis data and the one or more demand predictions pertaining to the at least one channel.

The techniques described in this disclosure provide a technical solution (e.g., that combine location tracking and predictive technologies) for overcoming the limitations associated with known techniques associated with determining conditions in channels. This technology-based solution marks an improvement over existing capabilities and functionalities related to processing data across multiple channels or geographic areas.

In certain embodiments, the techniques described herein can be utilized continuously at a scale that cannot be reasonably performed using manual techniques or the human mind. For example, in many embodiments, real-time information from large numbers of channels or geographic areas can be simultaneously processed and analyzed to provide real-time updates to client systems. This simultaneous processing of real-time data cannot be performed by a human mind.

Additionally, in certain embodiments, the techniques described herein solve a technical problem that arises only within the realm of computer networks, as machine learning networks do not exist outside the realm of computer networks.

Various embodiments include a computerized method comprising: providing access over a network to an analytics dashboard configured to generate and display channel analysis data associated with a plurality of channels that are monitored by an analytics platform; receiving, by the analytics dashboard, channel events pertaining to each of the plurality of channels over the network; receiving, via the analytics dashboard, a request designating at least one channel from a computing device over the network; in response to receiving the request, generating channel analysis data pertaining to the at least one channel based, at least in part, on the channel events corresponding to the at least one channel, the channel analysis data at least including one or more demand predictions pertaining to the at least one channel; and generating, by the analytics dashboard, an analytics display for presentation on the computing device that includes the channel analysis data and the one or more demand predictions pertaining to the at least one channel.

A number of embodiments include a system comprising one or more computing devices configured to perform: providing access over a network to an analytics dashboard configured to generate and display channel analysis data associated with a plurality of channels that are monitored by an analytics platform; receiving, by the analytics dashboard, channel events pertaining to each of the plurality of channels over the network; receiving, via the analytics dashboard, a request designating at least one channel from a computing device over the network; in response to receiving the request, generating channel analysis data pertaining to the at least one channel based, at least in part, on the channel events corresponding to the at least one channel, the channel analysis data at least including one or more demand predictions pertaining to the at least one channel; and generating, by the analytics dashboard, an analytics display for presentation on the computing device that includes the channel analysis data and the one or more demand predictions pertaining to the at least one channel.

Embodiments may include a computer program product accessible from a computer-usable or computer-readable medium providing program code for use by or in connection with a computer or any instruction execution system. A computer-usable or computer-readable medium may include any apparatus that stores, communicates, propagates, or transports the program for use by or in connection with the instruction execution system, apparatus, or device. The medium can be a magnetic, optical, electronic, electromagnetic, infrared, or semiconductor system (or apparatus or device) or a propagation medium. The medium may include a computer-readable storage medium, such as a semiconductor or solid-state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

It should be recognized that any features and/or functionalities described for an embodiment in this application can be incorporated into any other embodiment mentioned in this disclosure. Moreover, the embodiments described in this disclosure can be combined in various ways. Additionally, while the description herein may describe certain embodiments, features, or components as being implemented in software or hardware, it should be recognized that any embodiment, feature, or component that is described in the present application may be implemented in hardware, software, or a combination of the two.

While various novel features of the invention have been shown, described, and pointed out as applied to particular embodiments thereof, it should be understood that various omissions and substitutions, and changes in the form and details of the systems and methods described and illustrated, may be made by those skilled in the art without departing from the spirit of the invention. Amongst other things, the steps in the methods may be carried out in different orders in many cases where such may be appropriate. Those skilled in the art will recognize, based on the above disclosure and an understanding of the teachings of the invention, that the particular hardware and devices that are part of the system described herein, and the general functionality provided by and incorporated therein, may vary in different embodiments of the invention. Accordingly, the description of system components are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation. Variations, modifications, and other implementations of what is described herein may occur to those of ordinary skill in the art without departing from the spirit and scope of the present invention and its claims.

1. A system comprising:
one or more processors; and
one or more non-transitory computer-readable storage devices storing computing instructions configured to run on the one or more processors and cause the one or more processors to execute functions comprising:
providing access over a network to an analytics dashboard configured to generate and display channel analysis data associated with a plurality of channels that are monitored by an analytics platform;
receiving, by the analytics dashboard, channel events pertaining to each of the plurality of channels over the network;
receiving, via the analytics dashboard, a request designating at least one channel from a computing device over the network;
in response to receiving the request, generating channel analysis data pertaining to the at least one channel based, at least in part, on the channel events corresponding to the at least one channel, the channel analysis data at least including one or more demand predictions pertaining to the at least one channel; and
generating, by the analytics dashboard, an analytics display for presentation on the computing device that includes the channel analysis data and the one or more demand predictions pertaining to the at least one channel.

2. The system of claim 1, wherein the analytics display visualizes:
at least one demand prediction that indicates or predicts a demand for a current time period in in the at least one channel designated by the request; and
at least one demand prediction that indicates or predicts for a future time period demand in the at least one channel designated by the request.

3. The system of claim 1, wherein:
the analytics display generated by the analytics dashboard comprises an interactive map that comprises an overlay visualizing boundaries for the at least one channel and annotating the interactive map with one or more demand indicators identifying or predicting a demand in each of the at least one channels; and
the analytics dashboard generates the analytics display, at least in part, using the channel events corresponding to the at least one channel.

4. The system of claim 3, wherein:
the interactive map includes options that enables a plurality of verticals within the at least one channel to be selected; and
in response to receiving a selection of a vertical, the overlay is updated to display one or more demand indicators identifying or predicting the demand in the selected vertical for the at least one channel.

5. The system of claim 1, wherein:
the analytics dashboard includes, or communicates with, a machine learning network that is configured to generate the one or more demand predictions pertaining to the at least one channel;
the machine learning network extracts features from the channel events received over the network to generate the one or more demand predictions for the at least one channel; and
the machine learning network utilizes an anomaly detection or time series forecasting model to generate the one or more demand predictions for the at least one channel; and
the one or more demand predictions generated by the machine learning network are utilized to generate the analytics display.

6. The system of claim 1, wherein the analytics display generated by the analytics dashboard visualizes population density metrics for the at least one channel designated by the request.

7. The system of claim 1, wherein the analytics display generated by the analytics dashboard visualizes movement tracking metrics for the at least one channel designated by the request.

8. The system of claim 1, wherein the analytics display generated by the analytics dashboard visualizes vertical density metrics for the at least one channel designated by the request.

9. The system of claim 5, wherein: the anomaly detection model includes a classification model that is pre-trained using a supervised training procedure to generate the one or more demand predictions and the classification model generates the demand metric using one or more of the following:
a Naive Bayes classification model;
a OCSVM (One-class support vector machine) classification model;
a SVDD (Support Vector Data Description) classification model; or
a one-class K-means classification model.

10. The system of claim 1, wherein:
an application programming interface (API) enables the channel analysis data generated by the analytics dashboard to be accessed by one or more client systems; and
the channel analysis is accessed via the API is utilized by the one or more client systems to execute one or more demand adjustment functions.

11. A method implemented via execution of computing instructions configured to run at one or more processing devices and configured to be stored on non-transitory computer-readable media, the method comprising:
providing access over a network to an analytics dashboard configured to generate and display channel analysis data associated with a plurality of channels that are monitored by an analytics platform;
receiving, by the analytics dashboard, channel events pertaining to each of the plurality of channels over the network;
receiving, via the analytics dashboard, a request designating at least one channel from a computing device over the network;
in response to receiving the request, generating channel analysis data pertaining to the at least one channel based, at least in part, on the channel events corresponding to the at least one channel, the channel analysis data at least including one or more demand predictions pertaining to the at least one channel; and
generating, by the analytics dashboard, an analytics display for presentation on the computing device that includes the channel analysis data and the one or more demand predictions pertaining to the at least one channel.

12. The method of claim 11, wherein the analytics display visualizes:
at least one demand prediction that indicates or predicts a demand for a current time period in in the at least one channel designated by the request; and
at least one demand prediction that indicates or predicts for a future time period demand in the at least one channel designated by the request.

13. The method of claim 11, wherein:
the analytics display generated by the analytics dashboard comprises an interactive map that comprises an overlay visualizing boundaries for the at least one channel and annotating the interactive map with one or more demand indicators identifying or predicting a demand in each of the at least one channels;
the analytics dashboard generates the analytics display, at least in part, using the channel events corresponding to the at least one channel;
the interactive map includes options that enables a plurality of verticals within the at least one channel to be selected; and
in response to receiving a selection of a vertical, the overlay is updated to display one or more demand indicators identifying or predicting the demand in the selected vertical for the at least one channel.

14. The method of claim 11, wherein:
the analytics dashboard includes, or communicates with, a machine learning network that is configured to generate the one or more demand predictions pertaining to the at least one channel;
the machine learning network extracts features from the channel events received over the network to generate the one or more demand predictions for the at least one channel; and
the machine learning network utilizes an anomaly detection or time series forecasting model to generate the one or more demand predictions for the at least one channel; and
the one or more demand predictions generated by the machine learning network are utilized to generate the analytics display.

15. The method of claim 11, wherein the analytics display generated by the analytics dashboard visualizes population density metrics for the at least one channel designated by the request.

16. The method of claim 11, wherein the analytics display generated by the analytics dashboard visualizes movement tracking metrics for the at least one channel designated by the request.

17. The method of claim 11, wherein the analytics display generated by the analytics dashboard visualizes vertical density metrics for the at least one channel designated by the request.

18. The method of claim 14, wherein: the anomaly detection model includes a classification model that is pre-trained using a supervised training procedure to generate the one or more demand predictions and the classification model generates the demand metric using one or more of the following:
a Naive Bayes classification model;
a OCSVM (One-class support vector machine) classification model;
a SVDD (Support Vector Data Description) classification model; or
a one-class K-means classification model.

19. The method of claim 11, wherein:
an application programming interface (API) enables the channel analysis data generated by the analytics dashboard to be accessed by one or more client systems; and
the channel analysis is accessed via the API is utilized by the one or more client systems to execute one or more demand adjustment functions.

20. A computer program product, the computer program product comprising a non-transitory computer-readable medium including instructions for causing one or more computing devices to:
provide access over a network to an analytics dashboard configured to generate and display channel analysis data associated with a plurality of channels that are monitored by an analytics platform;
receive, by the analytics dashboard, channel events pertaining to each of the plurality of channels over the network;
receive, via the analytics dashboard, a request designating at least one channel from a computing device over the network;
in response to receiving the request, generate channel analysis data pertaining to the at least one channel based, at least in part, on the channel events corresponding to the at least one channel, the channel analysis data at least including one or more demand predictions pertaining to the at least one channel; and
generate, by the analytics dashboard, an analytics display for presentation on the computing device that includes the channel analysis data and the one or more demand predictions pertaining to the at least one channel.
